(19) United States
(12) Patent Application Publication
(10) Pub. No.: US 2020/0226954 A1
(43) Pub. Date: Jul. 16, 2020

(54) Electronic Seal (E-Seal) Device and Related Techniques

(71) Applicant: Vypin, LLC, Alpharetta, GA (US)

(72) Inventor: Robert W. Sengstaken, Jr., Hollis, NH (US)

(21) Appl. No.: 16/629,177

(22) PCT Filed: Jul. 9, 2018
(86) PCT No.: PCT/US2018/041245

§ 371 Date: Jan. 7, 2020

Related U.S. Application Data
(60) Provisional application No. 62/529,832, filed on Jul. 7, 2017.
(60) Provisional application No. 62/598,503, filed on Dec. 14, 2017.
(60) Provisional application No. 62/634,389, filed on Feb. 23, 2018.

(51) Int. Cl. G09F 3/03; H04L 9/32

(52) U.S. Cl. CPC G09F 3/0329; E05B 2047/0097; H04L 9/3228

(57) ABSTRACT

An electronic seal (e-seal) device and related techniques are disclosed. In accordance with some embodiments, the disclosed e-seal device may be configured to e-seal a given host platform. The disclosed e-seal device may include a radio frequency (RF) wireless transmitter configured, in accordance with some embodiments, to transmit a signal including data that may be compared against data from a server database in determining whether the e-seal has been compromised. When received by an authorized recipient within range, information from the signal may be delivered through the internet to the server database, which may be cloud-based in some instances, allowing for inter-networking of the system components and other elements as part of the internet of things (IOT). Reader and other computing devices may access the information stored at the server database to monitor and track the e-sealed platform, as well as control overall system operation.

### CROSS-REFERENCE TO RELATED APPLICATIONS

This patent application is a national stage entry under 35 U.S.C. § 371 of PCT International Patent Application No. PCT/US2018/041245, filed on Jul. 9, 2018. This patent application also claims the benefit of and priority to each of: (1) U.S. Provisional Patent Application No. 62/529,832, filed on Jul. 7, 2017; (2) U.S. Provisional Patent Application No. 62/598,503, filed on Dec. 14, 2017; and (3) U.S. Provisional Patent Application No. 62/634,389, filed on Feb. 23, 2018. Each of these patent applications is herein incorporated by reference in its entirety.

### FIELD OF THE DISCLOSURE

The present disclosure relates to electronic sealing systems and, more particularly, to electronic seal (e-seal) devices and related methods of monitoring.

### BACKGROUND

An electronic seal (e-seal) can be used to determine whether unauthorized access to a given sealed container has occurred, reducing the opportunity for theft, smuggling, and cargo tampering, among other hazards. Normally, the integrity of the e-seal may be detected at the destination.

### SUMMARY

The subject matter of this application may involve, in some cases, interrelated products, alternative solutions to a particular problem, and/or a plurality of different uses of a single system or article.

One example embodiment provides an electronic seal (e-seal) device configured to provide an e-seal for a host platform. The e-seal device includes an attachment portion configured to attach the e-seal device to the host platform. The e-seal device further includes a body portion. The body portion includes a locking receptacle portion configured to engage with the attachment portion. The body portion further includes an electronics assembly configured to detect whether the attachment portion is engaged with the locking receptacle portion. The electronics assembly includes a wireless transmitter configured to transmit a signal including data pertaining to an integrity of the e-seal and including a unique e-seal code associated with the e-seal. The electronics assembly further includes a processor configured to instruct the wireless transmitter to transmit the signal.

In some cases, the e-seal device is configured to transmit a new unique e-seal code in the signal each time the attachment portion is engaged with the locking receptacle portion.

In some cases, the e-seal code is an encrypted authentication code generated from a unique key stored by at least one of the e-seal device and a server database external to the e-seal device.

In some cases, the data pertaining to the integrity of the e-seal further includes: a unique identification associated with the e-seal device; and a status of at least one of the e-seal and the e-seal device. In some such instances, the signal further includes data pertaining to a group identifier associated with the e-seal device. In some other such instances, the signal further includes data pertaining to a power level of a power supply of the e-seal device. In some other such instances, the signal further includes data pertaining to at least one of: a usage count associated with a total quantity of e-seals provided by the e-seal device; and a usage time that the e-seal has existed.

In some cases, the signal is either a Bluetooth or a Wi-Fi signal of a frequency in an ISM band of between 2.4-2.485 GHz.

In some cases, the wireless transmitter includes a cellular modem configured to transmit the signal as a cellular signal.

In some cases, the processor is configured to instruct the wireless transmitter to transmit the signal in response to an unauthorized disengagement of the attachment portion from the locking receptacle portion.

In some cases: the electronics assembly further includes an engagement sensor; the attachment portion includes an insert portion disposed on an end thereof and configured to be inserted within the locking receptacle portion; and the engagement sensor is configured detect a presence of the insert portion within the locking receptacle portion in determining whether the attachment portion is engaged with the locking receptacle portion. In some such instances: the engagement sensor is an inductive sensor; and the insert portion includes a metal body configured to be detected by the inductive sensor in detecting the presence of the insert portion within the locking receptacle portion. In some other such instances: the engagement sensor is a magnetic sensor; and the insert portion hosts a magnetic source configured to be detected by the magnetic sensor in detecting the presence of the insert portion within the locking receptacle portion. In some other such instances: the engagement sensor is an electrical switch configured to toggle between open and closed positions; and the insert portion is configured to toggle the electrical switch between the open and closed positions upon insertion and withdrawal from the locking receptacle portion in detecting the presence of the insert portion within the locking receptacle portion.

In some cases, the attachment portion includes an electrically conductive trace embedded therein and configured to be electrically coupled with the electronics assembly. In some such instances, the processor is configured to instruct the wireless transmitter to transmit the signal in response to a breakage of the electrically conductive trace. In some other such instances, the attachment portion is configured as a generally U-shaped body having the electrically conductive trace embedded therein. In some other such instances, the attachment portion is configured as a flexible strap having the electrically conductive trace embedded therein.

In some cases, the electronics assembly further includes a motion detection sensor configured to detect at least one of movement of the e-seal device and an impact to the e-seal device.

In some cases, the attachment portion is configured as a peg having an electrical contact disposed at an end thereof and configured to be electrically coupled with the electronics assembly.

In some cases, the processor is configured to transition out of a sleep state upon engagement of the attachment portion with the locking receptacle portion.

In any of the aforementioned cases: the host platform is a semi-trailer; and the attachment portion is configured to interface with at least one of a door and a latching mechanism of the semi-trailer.

In any of the aforementioned cases: the host platform is a shipping container; and the attachment portion is configured to interface with an enclosure mechanism of the shipping or cargo container.

In any of the aforementioned cases: the host platform is a firearm; and the attachment portion is configured to interface with at least one of a breech, a barrel, a magazine well, and a trigger guard of the firearm.

Another example embodiment provides a method of providing an electronic seal (e-seal) via an e-seal device. The method includes generating a unique e-seal code associated with the e-seal upon engagement of an attachment portion of the e-seal device with a locking receptacle portion of the e-seal device. The method further includes transmitting, via a wireless transmitter of the e-seal device, a signal including data pertaining to an integrity of the e-seal, the data including the unique e-seal code associated with the e-seal.

In some cases, the transmitting occurs each time the attachment portion is engaged with the locking receptacle portion.

In some cases, the e-seal code is an encrypted authentication code generated from a unique key stored by at least one of the e-seal device and a server database external to the e-seal device.

In some cases, the data pertaining to the integrity of the e-seal further includes: a unique identification associated with the e-seal device; and a status of at least one of the e-seal and the e-seal device. In some such instances, the signal further includes data pertaining to a group identifier associated with the e-seal device. In some other such instances, the signal further includes data pertaining to a power level of a power supply of the e-seal device. In some other such instances, the signal further includes data pertaining to at least one of: a usage count associated with a total quantity of e-seals provided by the e-seal device; and a usage time that the e-seal has existed.

In some cases, the signal is either a Bluetooth or a Wi-Fi signal of a frequency in an ISM band of between 2.4-2.485 GHz.

In some cases, the wireless transmitter includes a cellular modem configured to transmit the signal as a cellular signal.

In some cases, the method further includes instructing, via a processor of the e-seal device, the wireless transmitter to transmit the signal. In some such instances, the instructing via the processor occurs in response to an unauthorized disengagement of the attachment portion from the locking receptacle portion. In some other such instances, the instructing via the processor occurs in response to breakage of an electrically conductive trace that is embedded in the attachment portion and electrically coupled with an electronics assembly of the e-seal device. In some other such instances, the method further includes transitioning the processor out of a sleep state upon engagement of the attachment portion with the locking receptacle portion.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIGS. 1-2 illustrate several views of an electronic seal (e-seal) device configured in accordance with an embodiment of the present disclosure.

FIGS. 3-4 illustrate several views of a body portion configured in accordance with an embodiment of the present disclosure.

FIGS. 5-11 illustrate several views of a housing configured in accordance with an embodiment of the present disclosure.

FIG. 12 illustrates an electronics assembly configured in accordance with an embodiment of the present disclosure.

FIG. 13 is a block diagram of an electronics assembly configured in accordance with an embodiment of the present disclosure.

FIGS. 14-15 illustrate an attachment portion configured in accordance with an embodiment of the present disclosure.

FIGS. 16-21 illustrate several views of an insert portion configured in accordance with an embodiment of the present disclosure.

FIGS. 22-24 illustrate several views of an insert portion including a metal body configured in accordance with an embodiment of the present disclosure.

FIGS. 25-28 illustrate several views of an electrically conductive trace interfaced with an insert portion of an attachment portion, in accordance with an embodiment of the present disclosure.

FIGS. 29-31 illustrate several views of a collar portion configured in accordance with an embodiment of the present disclosure.

FIGS. 32-36 illustrate several views of an arrangement of an insert portion of an attachment portion with respect to an engagement sensor, in accordance with an embodiment of the present disclosure.

FIGS. 37-38 illustrate several views of a key configured in accordance with an embodiment of the present disclosure.

FIG. 39 illustrates a key configured in accordance with another embodiment of the present disclosure.

FIGS. 40-43 illustrate several views demonstrating operative engagement between a key and an insert portion of an attachment portion in accordance with an embodiment of the present disclosure.

FIG. 44 illustrates an e-seal device configured in accordance with another embodiment of the present disclosure.

FIG. 45 illustrates an e-seal device configured in accordance with another embodiment of the present disclosure.

FIG. 46 represents several data fields of a data packet which may be transmitted in a signal by an e-seal device, in accordance with an embodiment of the present disclosure.

FIG. 47 illustrates a wireless e-seal monitoring system configured in accordance with an embodiment of the present disclosure.

FIG. 48 is a flow diagram of a method of generating an e-seal, as provided by an e-seal device, in accordance with an embodiment of the present disclosure.

FIG. 49 is a flow diagram of a method of terminating an e-seal, as provided by an e-seal device, in accordance with another embodiment of the present disclosure.

FIG. 50 is a flow diagram of a method of terminating an e-seal, as provided by an e-seal device, in accordance with an embodiment of the present disclosure.

FIG. 51 illustrates an example use of an e-seal device with a semi-trailer, in accordance with an embodiment of the present disclosure.

FIG. 52 illustrates an example use of an e-seal device with a shipping container, in accordance with an embodiment of the present disclosure.

FIG. 53 illustrates an example use of an e-seal device with a firearm, in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

An electronic seal (e-seal) device and related techniques are disclosed. In accordance with some embodiments, the disclosed e-seal device may be configured to e-seal a given host platform. The disclosed e-seal device may include a radio frequency (RF) wireless transmitter configured, in accordance with some embodiments, to transmit a signal including data that may be compared against data from a server database in determining whether the e-seal has been compromised. When received by an authorized recipient within range, information from the signal may be delivered through the internet to the server database, which may be cloud-based in some instances, allowing for inter-networking of the system components and other elements as part of the internet of things (IOT). Reader and other computing devices may access the information stored at the server database to monitor and track the e-sealed platform, as well as control overall system operation. Numerous configurations and variations will be apparent in light of this disclosure.

General Overview

Several existing approaches to electronically sealing a door of a shipping container or tractor trailer provide a visual verification that the door has not been opened and the contents tampered with. However, these approaches require a special tool to lock a bolt and then cut it off. Some of these devices involve use of a passive radio frequency identification (RFID) chip that can be read upon delivery to verify the serial number of the seal. Thus, if the device is cut, the RFID chip can no longer be read, thereby providing means for electronically detecting that the seal has been compromised. These RFID-based seals can be read with a hand-held RFID reader or with a fixed mounted RFID reader at a gate as the truck carrying the semi-trailer or shipping container hosting the sealing device passes through. As will be appreciated, RFID-based solutions require a very expensive infrastructure to read tags automatically at a gate, which requires periodic maintenance to keep the system operational. Furthermore, with existing approaches, the state of the seal cannot be read automatically by the driver and uploaded to a server database while the host platform is in transit. Moreover, the RFID tags are costly, in some cases being as much as five times as expensive as a seal without RFID monitoring capabilities. After use, these existing RFID tags are cut for removal and, therefore, are not reusable.

Thus, and in accordance with some embodiments, an electronic seal (e-seal) device and related techniques are disclosed. In accordance with some embodiments, the disclosed e-seal device may be configured to e-seal a given host platform. The disclosed e-seal device may include a radio frequency (RF) wireless transmitter configured, in accordance with some embodiments, to transmit a signal including data that may be compared against data from a server database in determining whether the e-seal has been compromised. When received by an authorized recipient within range, information from the signal may be delivered through the internet to the server database, which may be cloud-based in some instances, allowing for inter-networking of the system components and other elements as part of the internet of things (IOT). Reader and other computing devices may access the information stored at the server database to monitor and track the e-sealed platform, as well as control overall system operation.

Generally, the disclosed e-seal device is not necessarily designed to serve as a lock or other physical deterrence apparatus, though in some cases it optionally may be configured to serve as such. Rather, the disclosed e-seal device may be configured, in accordance with some embodiments, to detect and securely report on whether the e-seal has been compromised. To that end, the disclosed e-seal device may be configured, in accordance with some embodiments, to detect (1) whether its attachment portion has been disengaged from its locking receptacle portion without use of an authorized key and/or (2) whether a circuit through its attachment portion has been broken.

In accordance with some embodiments, the wireless transmitter of the disclosed e-seal device may be configured to communicate via a Bluetooth communication protocol, such as the Bluetooth Low Energy (BLE) protocol. As will be appreciated in light of this disclosure, use of a BLE protocol may provide advantages, as it may be read using a mobile computing device, such as a smartphone or tablet computer, or a gateway device and powered from a battery or other low-cost power source. However, the present disclosure is not intended to be so limited, as any of a wide range of other suitable RF protocols may be employed, in accordance with some other embodiments. In some embodiments, the wireless transmitter may communicate via a cellular signal.

As will be appreciated in light of this disclosure, the disclosed e-seal device may be utilized in any of a wide range of contexts. For instance, in accordance with some embodiments, the disclosed e-seal device may be configured to provide e-sealing for any of a wide range of platforms, including semi-trailers, shipping/cargo containers, firearms, sterilized medical equipment containers, hazardous materials containers, medication containers, and food/drink containers, to name a few. In a more general sense, the disclosed e-seal device may be utilized with any compatible container or item, whether a high-value asset or otherwise, to detect whether unauthorized access has occurred.

In accordance with some embodiments, the status of an e-seal provided by an e-seal device configured as described herein may be monitored (e.g., in real-time or otherwise as desired) by an application on a smartphone or other reader device while the host platform is in transit, thus providing for the reporting of location information if/when the e-seal is compromised. Also, un using active RF technology, the disclosed e-seal device (as hosted by a given host platform) can be read easily and quickly as it passes by a given monitoring point having a gateway (or other low-cost reader) that forwards data obtained from the e-seal device to a server or other network element to determine whether the e-seal has been compromised. Thus, the e-seal device can be read, for instance, from the cab of a truck, as well as by a low-cost gateway at the gate at origin/destination. Furthermore, in accordance with some embodiments, the disclosed e-seal device may be configured, in a general sense, as a reusable device, which may realize reductions in cost-per-use and reduced waste as compared to existing RFID-based disposable seals.

Device Structure and Operation

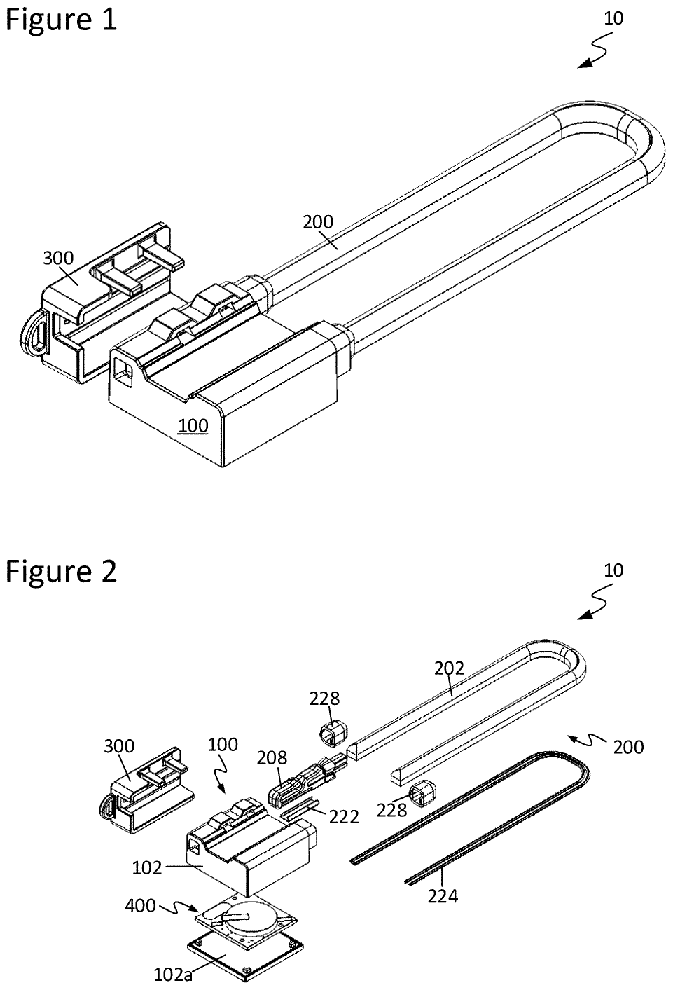

FIGS. 1-2 illustrate several views of an electronic seal (e-seal) device 10 configured in accordance with an embodiment of the present disclosure. As can be seen, e-seal device 10 may include a body portion 100, an attachment portion 200, and a key 300, each discussed in turn below. As described herein, e-seal device 10 may be configured, in accordance with some embodiments, to be attached to a given host platform 20 (e.g., such as a semi-trailer 22, shipping container 24, or firearm 26, to name a few) and provide an e-seal which may be monitored for its integrity. As further described herein, e-seal device 10 may be configured to detect whether the e-seal has been compromised through any (or all): (1) detection, via engagement sensor 404, of engagement/disengagement of attachment portion 200 and locking receptacle portion 104; (2) detection of maintenance/breakage of an electrical circuit provided by electrically conductive trace(s) 224 (embedded within attachment portion 200) electrically coupled with electronics assembly 400; and (3) detection of motion by motion detection sensor 422. In accordance with some embodiments, by either (or both) of these mechanisms, e-seal device 10 may be utilized to monitor the establishment, maintenance, and termination (through authorized or unauthorized means) of an e-seal provided in attaching e-seal device 10 to a given host platform 20. In this manner, e-seal device 10 may be utilized, for example, in preventing and/or monitoring unauthorized activities with the e-sealed platform 20, such as access, use, theft, vandalism, or harm to the host platform 20. In accordance with some embodiments, e-seal device 10 may not be configured to be a locking device, although in some cases, such locking optionally may be provisioned.

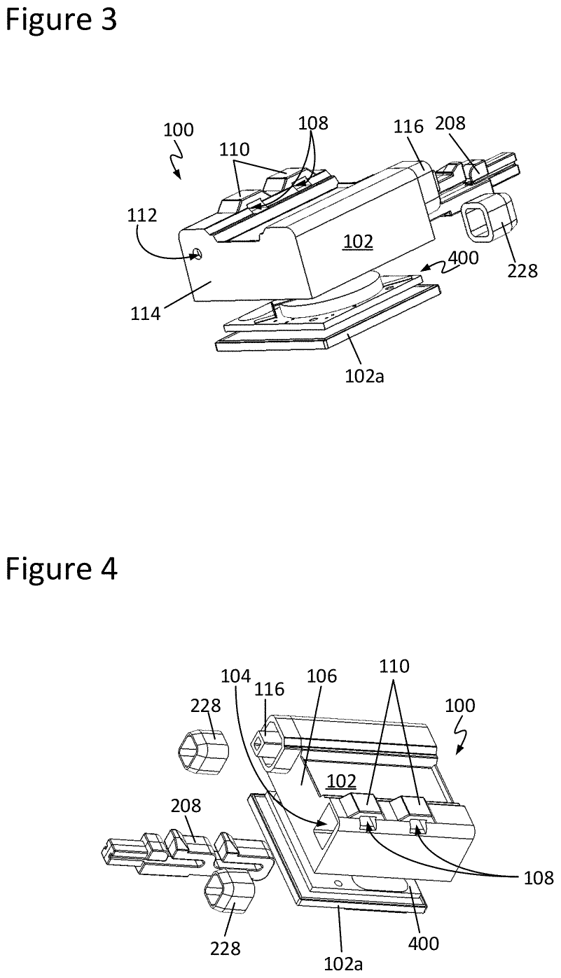

FIGS. 3-4 illustrate several views of a body portion 100 configured in accordance with an embodiment of the present disclosure. Body portion 100 may be configured, in accordance with some embodiments, to be operatively interfaced with attachment portion 200, as discussed herein. Body portion 100 also may be configured, in accordance with some embodiments, to be operatively interfaced with a key 300 to effectuate disengagement of attachment portion 200 from body portion 100, as discussed herein. Body portion 100 also may be configured, in accordance with some embodiments, to contain the electronics assembly 400 of e-seal device 10, as discussed herein.

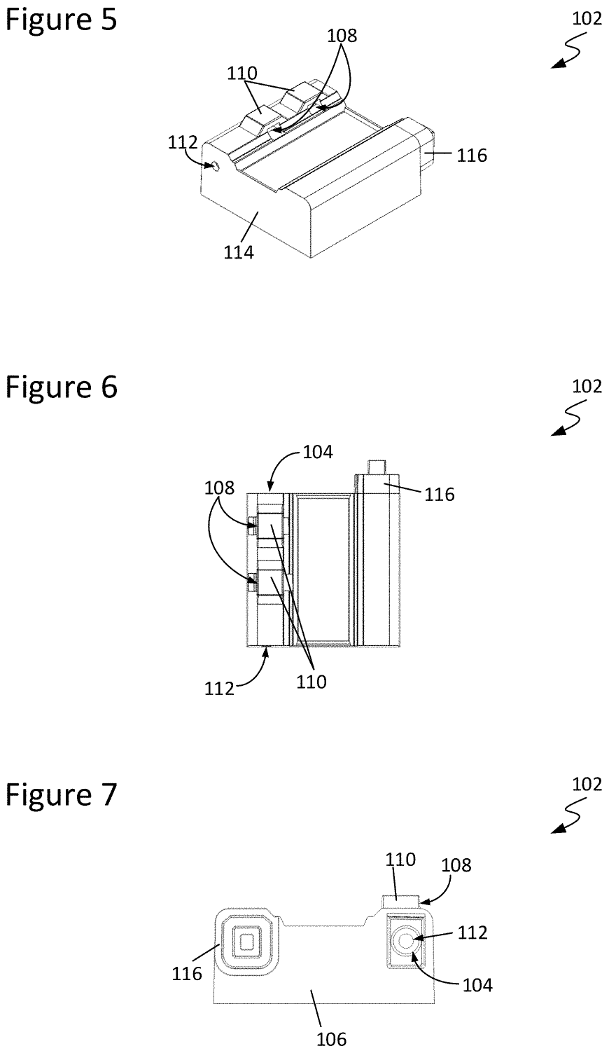

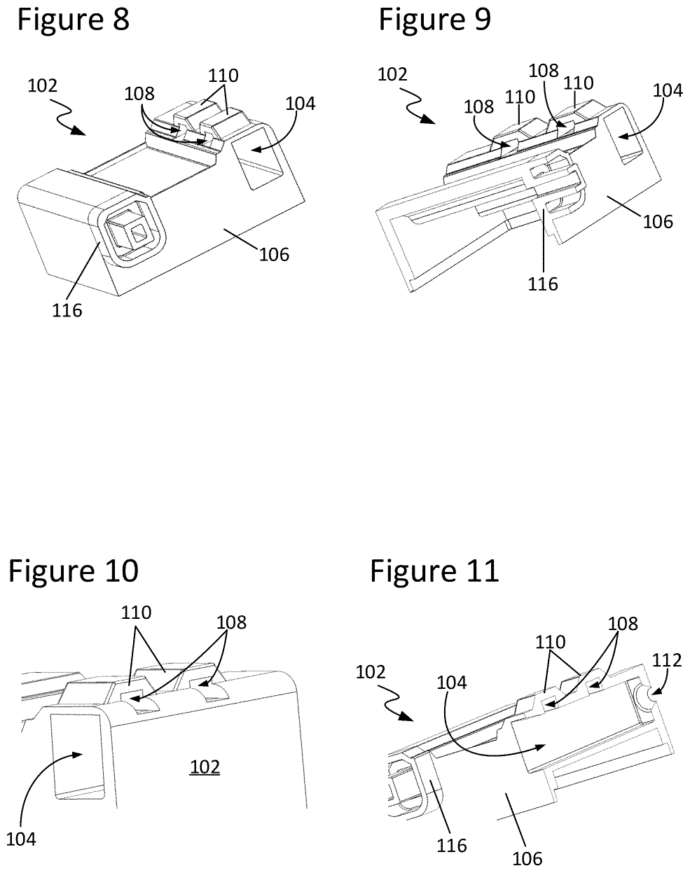

Body portion 100 may include a housing 102. FIGS. 5-11 illustrate several views of a housing 102 configured in accordance with an embodiment of the present disclosure. Housing 102 may be configured, in accordance with some embodiments, to house and protect various components of e-seal device 10, including electronics assembly 400. To such end, housing 102 may be, at least in some embodiments, substantially impervious to environmental hazards, such as dust and water. This may help to prevent (or otherwise reduce) exposure of electronics assembly 400 and other components internal to housing 102 to moisture and debris, limiting the opportunity for corrosion, electrical shorting, and other types of damage to e-seal device 10. The dimensions, geometry, and material construction of housing 102 may be customized, as desired for a given target application or end-use. In some embodiments, housing 102 may be a closed structure, having no open sides, whereas in some other embodiments, housing 102 may have an open side (e.g., open back side) and, thus, an optional sealing plate 102a may be provided to seal the open side.

Body portion 102 also may include a locking receptacle portion 104 defined therein. Locking receptacle portion 104 may be configured, in accordance with some embodiments, to operatively engage with (e.g., receive and retain) attachment portion 200 in a manner that prevents attachment portion 200 from inadvertently disengaging from locking receptacle portion 104. Locking receptacle portion 104 may be accessible from a front end 106 of housing 102. The opening of locking receptacle portion 104 also may be configured, in accordance with some embodiments, to be operatively interfaced with a collar portion 228 (discussed below) in operatively coupling attachment portion 200 with insert portion 208. The dimensions and geometry of locking receptacle portion 104 may be customized, as desired for a given target application or end-use.

Housing 102 may include one or more openings 108 formed therein and one or more corresponding covers 110 formed thereover, above locking receptacle portion 104. A given opening 108 may be a passageway that accesses the interior of locking receptacle portion 104. The dimensions, geometry, and quantity of opening(s) 108 may be customized, as desired for a given target application or end-use.

In some embodiments, housing 102 optionally may include one or more drainage holes 112 situated at a rear end 114 thereof to permit locking receptacle portion 104 to drain (e.g., by gravity). A given drainage hole 112 may be a passageway that accesses the interior of locking receptacle portion 104. The dimensions, geometry, and quantity of drainage hole(s) 112 may be customized, as desired for a given target application or end-use.

Housing 102 may include an attachment point 116 configured, in accordance with some embodiments, to be the point at which attachment portion 200 is affixed, in a temporary or permanent manner, thereto. In some embodiments, attachment point 116 may include a passageway defined therein through which electrically conductive trace(s) 224 (discussed below) may pass to electrically connect with electronics assembly 400 within housing 102. Attachment point 116 also may be configured, in accordance with some embodiments, to be operatively interfaced with a collar portion 228 (discussed below) to affix attachment portion 200 thereat.

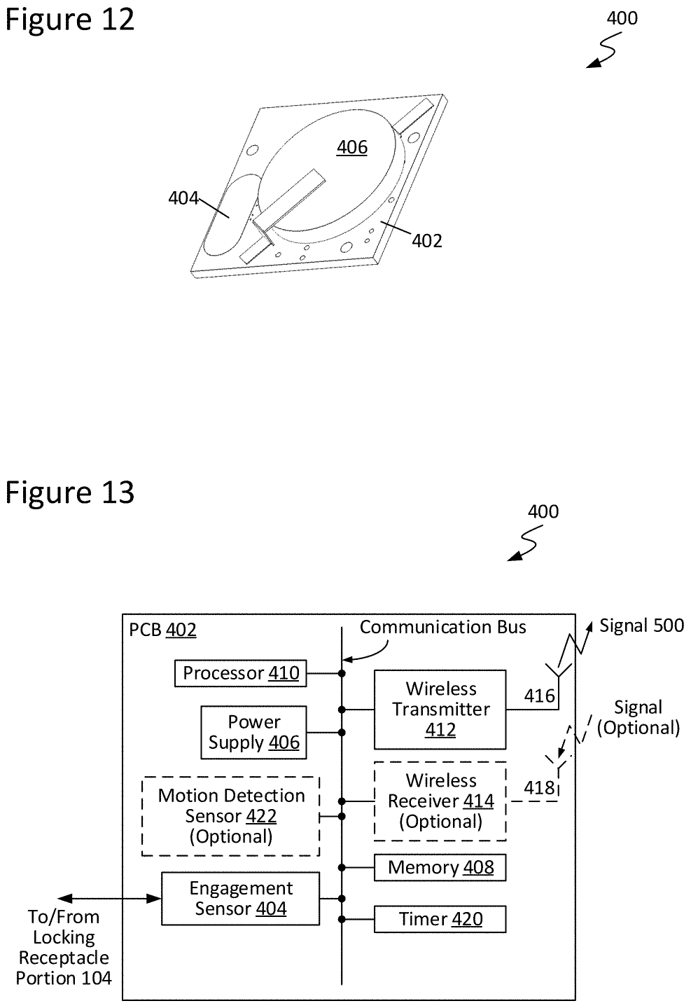

As previously noted, body portion 100 may be configured, in accordance with some embodiments, to contain (or otherwise host), in part or in whole, electronics assembly 400 of e-seal device 10. FIG. 12 illustrates an electronics assembly 400 configured in accordance with an embodiment of the present disclosure. FIG. 13 is a block diagram of an electronics assembly 400 configured in accordance with an embodiment of the present disclosure. In accordance with some embodiments, any (or all) of the various electronic components of electronics assembly 400 may be populated on one or more printed circuit boards (PCBs) 402 or other suitable intermediate(s) or substrate(s). In accordance with some embodiments, any (or all) of the various electronic components of electronics assembly 400 may communicate with one another via a communication bus or other suitable interconnect.

Electronics assembly 400 may include an engagement sensor 404. Engagement sensor 404 may be configured, in accordance with some embodiments, to detect engagement/disengagement of attachment portion 200 with locking receptacle portion 104 of body portion 100. To that end, engagement sensor 404 may be configured, in accordance with some embodiments, to detect whether insert portion 208 is disposed within locking receptacle portion 104. Thus, engagement sensor 404 may be utilized in monitoring the establishment, integrity, and termination of an e-seal provided in operatively interfacing attachment portion 200 and locking receptacle portion 104 to attach e-seal device 10 to host platform 20.

In accordance with some embodiments, engagement sensor 404 may be configured to detect whether insert portion 208 is present within locking receptacle portion 104 continuously, periodically (e.g., at fixed or variable intervals), on-demand, or otherwise as desired. When insert portion 208 is inserted into locking receptacle portion 104 and detected by engagement sensor 404, engagement sensor 404 may output a corresponding signal indicative of the state of engagement to processor 410 (discussed below). Conversely, when insert portion 208 is withdrawn from locking receptacle portion 104 and no longer detected by engagement sensor 404, engagement sensor 404 may output a corresponding signal indicative of the state of disengagement to processor 410.

Engagement sensor 404 may be of any of a wide range of configurations and may utilize any one, or combination, of inductive, magnetic, capacitive, electrical, and optical sensing techniques, among others. For instance, in some embodiments, engagement sensor 404 may be an inductive sensor configured to detect a change in inductance when a metal body (e.g., such as metal body 222 of insert portion 208, discussed below) is disposed within its magnetic field. In some cases, such an inductive-type engagement sensor 404 may be configured to detect over a very short distance (e.g., about 10 mm or less, about 8 mm or less, or about 6 mm or less) within housing 102. In some embodiments, engagement sensor 404 may be, for example, a printed electrically conductive coil situated populated on PCB 402.

In some other embodiments, engagement sensor 404 may be a magnetic sensor configured to detect whether a magnetic source (e.g., hosted by insert portion 208, discussed below) is disposed within its magnetic field. As will be appreciated in light of this disclosure, it may be desirable to configure such a magnetic-type engagement sensor 404 such that it cannot be defeated by application of a magnetic field external to housing 102.

In some other embodiments, engagement sensor 404 may be an electrical switch configured to toggle between closed and open positions upon insertion or withdrawal of insert portion 208 within locking receptacle portion 104. For instance, in accordance with some embodiments, when insert portion is inserted within locking receptacle portion 104, the switch-type engagement sensor 404 may close, completing an electrical circuit. Conversely, when insert portion is withdrawn from locking receptacle portion 104, the switch-type engagement sensor 404 may open, breaking the electrical circuit. Of course, the present disclosure is not intended to be so limited, as in accordance with some other embodiments, insertion of insert portion 208 may open the switch, breaking the circuit, whereas withdrawing of insert portion may close the switch, completing the circuit. In this manner, the switch-type engagement sensor 404 may be utilized to detect the presence/absence of insert portion 208 based on completion or breakage of an electrical circuit.

Electronics assembly 400 may include a power supply 406. Power supply 406 may be configured, in accordance with some embodiments, to supply a given target amount of power to any of the various components of electronics assembly 400 (or e-seal device 10, more generally). In some embodiments, power supply 406 may be a battery, which may be permanent or replaceable. In some cases, power supply 406 may include or be operatively coupled with a photovoltaic module (e.g., a solar cell) configured to convert light energy to electrical energy for use by e-seal device 10.

Electronics assembly 400 may include memory 408. Memory 408 may be implemented with any one, or combination, of volatile and non-volatile memory and may be of any type and size, as desired for a given target application or end-use. In some cases, memory 408 may be configured for use in storing data, on a temporary or permanent basis, whether that data is native to e-seal device 10 or received from another source (e.g., such as a reader device 1010, a cellular network element, server database 1006, or computing device 1008, each discussed below). Memory 408 may be configured, in accordance with some embodiments, for use as processor workspace for processor 410 (discussed below).

In accordance with some embodiments, memory 408 may be (or otherwise include) a computer-readable medium that, when executed by a processor (e.g., such as processor 410), carries out any one or more of the functions described herein, in part or in whole. The computer-readable medium may be, for example, a hard drive, a compact disk, a memory stick, a server, or any other suitable non-transitory computer or computing device memory that includes executable instructions, or a plurality or combination of such memories. Other embodiments can be implemented, for instance, with gate-level logic or an application-specific integrated circuit (ASIC) or chip set, or other such purpose-built logic. Some embodiments can be implemented with a microcontroller having input/output (I/O) capability (e.g., inputs for receiving user inputs; outputs for directing other components) and one or more embedded routines for carrying out device functionality. In a more general sense, memory 408 may be implemented in hardware, software, firmware, or a combination thereof, as desired for a given target application or end-use.

Electronics assembly 400 may include a processor 410. Processor 410 may be configured, in accordance with some embodiments, to communicate with any one, or combination, of the other various electronic components of e-seal device 10 via a communication bus or other suitable interconnect. Processor 410 may be, for example, a central processing unit (CPU), a microcontroller unit (MCU), or any other suitable processing element, as will be apparent in light of this disclosure. In performing a given operation associated with e-seal device 10, processor 410 may be configured to access data stored at memory 408 or otherwise accessible to e-seal device 10.

As previously noted, when engagement sensor 404 detects engagement/disengagement of attachment portion 200 and locking receptacle portion 104, it may output a corresponding signal indicative of the state of engagement/disengagement to processor 410. When so alerted, processor 410 may process data received via that signal, in accordance with some embodiments. Processor 410 may be configured, in accordance with some embodiments, to process, in part or in whole, any of the state machine logic states of e-seal device 10. Moreover, processor 410 may be used in transitioning between such states.

Processor 410 may be configured, in accordance with some embodiments, to communicate with wireless transmitter 412 (discussed below). In accordance with some embodiments, removing, damaging, or tampering with e-seal device 10 may cause processor 410 to output a signal instructing wireless transmitter 412 to transmit, immediately or otherwise as desired, a signal 500 (discussed below) including an alert as to the compromised status of the e-seal. In accordance with some embodiments, processor 410 may be configured to check the power level of power supply 406 periodically or as otherwise desired. In some embodiments, processor 410 may include an integrated timer (e.g., such as timer 420, discussed below).

Electronics assembly 400 may include a wireless transmitter 412. Wireless transmitter 412 may be either a dedicated transmitter device provided with only transmitting capabilities or a transceiver device provided with both transmitting and receiving capabilities. Wireless transmitter 412 may be configured, in accordance with some embodiments, to communicate via one or more radio frequency (RF) communication protocols. For instance, in some embodiments, wireless transmitter 412 may be configured to communicate via a Bluetooth communication protocol, such as Bluetooth Low Energy (BLE) protocol. In some embodiments, wireless transmitter 412 may be configured to transmit and/or receive Bluetooth signals of a frequency in an ISM band of between 2.4-2.485 GHz. To such ends, wireless transmitter 412 may be, in an example embodiment, an active short-wavelength ultra-high frequency (UHF) radio wave Bluetooth-compatible device configured to transmit and/or receive Bluetooth signals. In some other embodiments, wireless transmitter 412 may be configured to communicate via a cellular communication protocol. To such ends, wireless transmitter 412 may be, in an example embodiment, an active cellular modem or other cellular-compatible device configured to transmit and/or receive cellular signals. In some still other embodiments, wireless transmitter 412 may be configured to communicate via a Wi-Fi communication protocol. To such ends, wireless transmitter 412 may be, in an example embodiment, a Wi-Fi-compatible device configured to transmit and/or receive Wi-Fi signals, for instance, of a frequency in an ISM band of between 2.4-2.485 GHz.

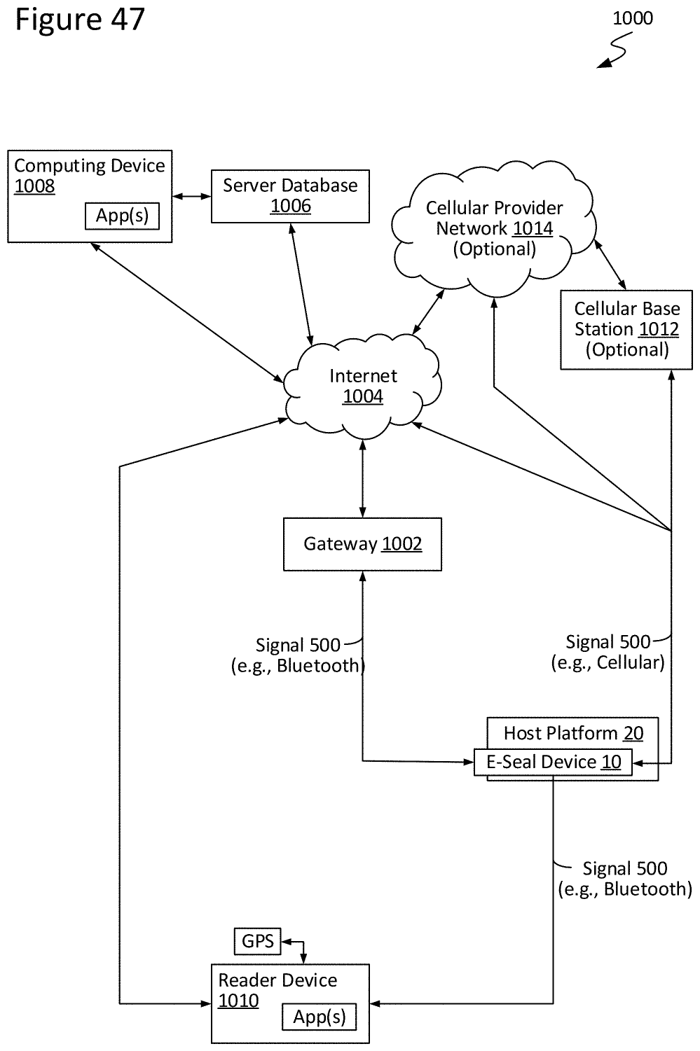

In accordance with some embodiments, wireless transmitter 412 may be configured to transmit a signal 500 (discussed below). Wireless transmitter 412 may be configured, in accordance with some embodiments, to transmit signal 500 continuously, periodically (e.g., at fixed or variable intervals), on-demand, or otherwise as desired. The repetition rate and transmission power at which wireless transmitter 412 transmits signal 500 may be varied, as desired for a given target application or end-use. As previously noted, in some instances, wireless transmitter 412 may transmit signal 500 upon instruction from processor 410. In some embodiments in which wireless transmitter 412 is configured to send signal 500 as a cellular signal, data from e-seal device 10 may be sent over a cellular data pathway without involvement of a gateway 1002 (see FIG. 47).

Electronics assembly 400 also optionally may include a wireless receiver 414. Wireless receiver 414 may be either a dedicated receiver device provided with only receiving capabilities or a transceiver device provided with both receiving and transmitting capabilities. As will be appreciated in light of this disclosure, wireless receiver 414 may be configured to communicate via any of the example RF communication protocols discussed above, for instance, with respect to wireless transmitter 412, in accordance with some embodiments. In accordance with some embodiments, wireless receiver 414 may listen (e.g., periodically or otherwise as desired) for an incoming data packet and, upon reception of a valid data packet, send a wake-up signal to processor 410.

As a wireless communication device, wireless transmitter 412 may include an antenna 416 and (optional) wireless receiver 414 may include an antenna 418. A given antenna 416, 418 may be configured, in accordance with some embodiments, to transmit and/or receive one or more RF signals, such as a signal 500 (discussed below). To that end, a given antenna 416, 418 may be, for example, a printed circuit board (PCB) antenna configured as typically done or any other suitable antenna, as will be apparent in light of this disclosure.

Electronics assembly 400 may include a timer 420. Timer 420 may be implemented in hardware, software, firmware, or some combination thereof. In some embodiments, timer 420 may be integrated with processor 410, whereas in some other embodiments, timer 420 and processor 410 may be separate and distinct components. Timer 420 may be configured, in accordance with some embodiments, to serve any of several functions in the context of e-seal device 10. For instance, in some embodiments, timer 420 may be configured to track the usage time of e-seal device 10; that is, timer 420 may track the elapsed time that an e-seal has existed, beginning when attachment portion 200 and locking receptacle portion 104 are engaged and ending when they are disengaged (with or without authorization). In some embodiments, timer 420 may be configured to control (e.g., using processor 410) the timing of transmissions of signal 500 via wireless transmitter 412. To that end, timer 420 may be configured to output a wake-up signal to processor 410 at a given repetition rate, which may be customized, as desired for a given target application or end-use. In response to receipt of the wake-up signal from timer 420, processor 410 may transition out of a low-power state (e.g., a sleep-state or an off-state) and send another wake-up signal to wireless transmitter 412 and instruct it to transmit signal 500.

Electronics assembly 400 optionally may include a motion detection sensor 422. Motion detection sensor 422 may be configured, in accordance with some embodiments, as a micro-electromechanical system (MEMS) accelerometer device or any other suitable motion detection device, as will be apparent in light of this disclosure. In accordance with some embodiments, motion detection sensor 422 may be configured to detect movement (e.g., translational movement, rotational movement, and so on) of e-seal device 10 or an impact to e-seal device 10 (e.g., such as a single-tap or double-tap on housing 102). Motion detection sensor 422 may be configured, in accordance with some embodiments, to output a wake-up signal to processor 410 in response to its activation as caused by the movement or impact. In response to receipt of this wake-up signal, processor 410 may transition out of a low-power state (e.g., a sleep-state or an off-state) and send another wake-up signal to wireless transmitter 412 and instruct it to transmit signal 500. In some cases in which an optional wireless receiver 414 is provisioned, motion detection sensor 422 may be configured, in accordance with some embodiments, to output a wake-up signal to wireless receiver 414 in response to its activation as caused by the movement or impact. In this manner, wireless receiver 414 may remain in a low-power state (e.g., a sleep-state or off-state) until e-seal device 10 is moved or impacted, at least in some embodiments.

Electronics assembly 400 optionally may include any of a wide range of additional and/or different components from those described above. For instance, in accordance with some embodiments, electronics assembly 400 optionally may include a radio-frequency identification (RFID) module. Such RFID module may be configured, in accordance with some embodiments, to at least one of transmit and receive one or more RFID signals. To such ends, the RFID module may any suitable standard, custom, or proprietary RFID module, as desired for a given target application or end-use. The optional RFID module may communicate with any of the various other electronic components of electronics assembly 400 via a communication bus or other suitable interconnect.

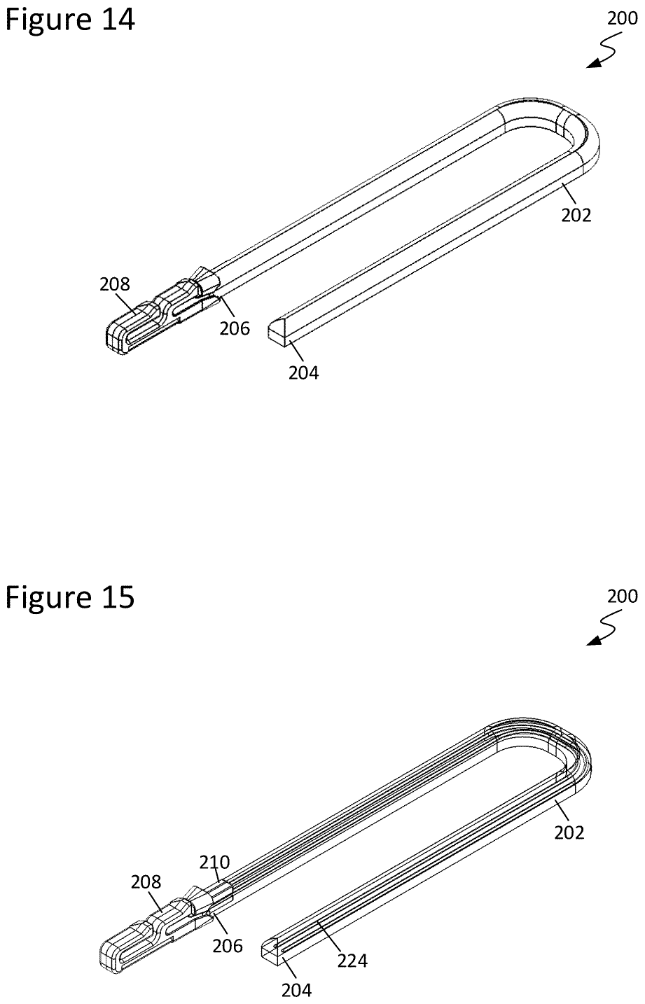

Returning to FIGS. 1-2, as can be seen, e-seal device 10 may include an attachment portion 200. FIGS. 14-15 illustrate an attachment portion 200 configured in accordance with an embodiment of the present disclosure. Attachment portion 200 may be configured, in accordance with some embodiments, to attach e-seal device 10 to a given host platform 20.

Attachment portion 200 may include a body portion 202. In accordance with some embodiments, a first end 204 of body portion 202 may be configured to be operatively interfaced with attachment point 116 (of body portion 100) and held in engagement thereat by a first collar portion 228 (discussed below). In accordance with some embodiments, a second end 206 of body portion 202 may be configured to be operatively interfaced with insert portion 208 (discussed below) and held in engagement therewith by a second collar portion 228. The dimensions, geometry, and material composition of body portion 202 may be customized, as desired for a given target application or end-use. In some embodiments, body portion 202 may be configured as a generally U-shaped shackle, which may be rigid or flexible, as desired. In a general sense, such an attachment portion 200 may be similar in configuration and/or purpose to a shackle as may be found, for instance, on a typical padlock. In some embodiments, body portion 202 may be a solid bar, whereas in some other embodiments, body portion 202 may be a flexible cable (optionally woven), strap, or segmented or articulable body.

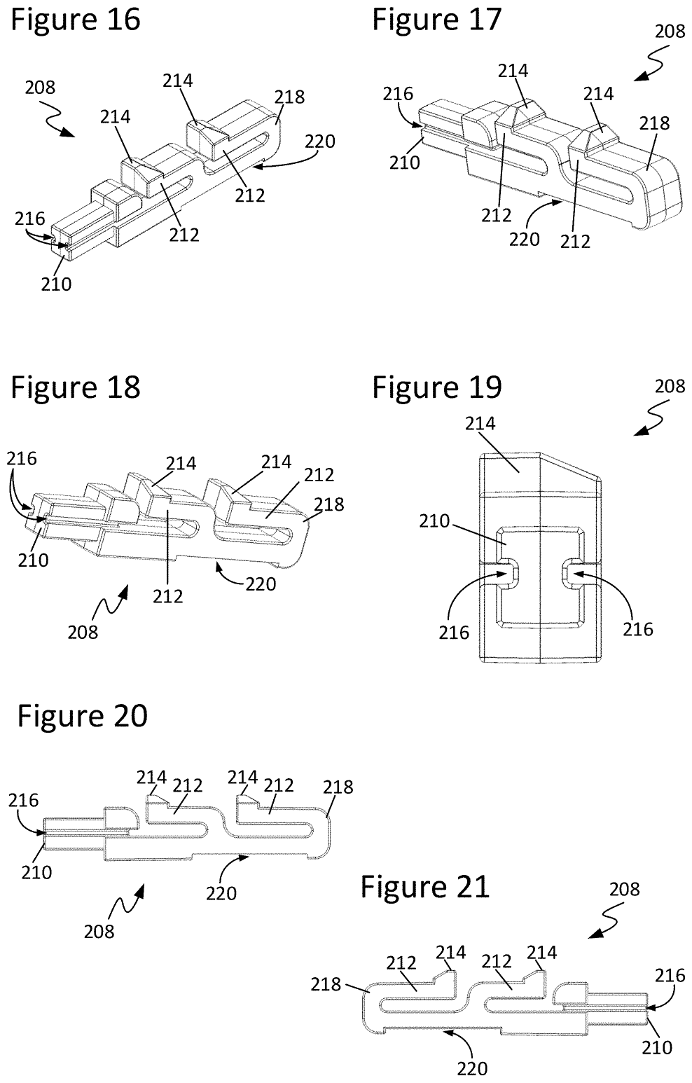

Attachment portion 200 also may include an insert portion 208. FIGS. 16-21 illustrate several views of an insert portion 208 configured in accordance with an embodiment of the present disclosure. In accordance with some embodiments, a forward end 210 of insert portion 208 may be configured to be operatively coupled with attachment portion 200 (e.g., at a second end 206 thereof). Insert portion 208 may be configured, in accordance with some embodiments, to be inserted within (e.g., received and retained by) locking receptacle portion 104. In accordance with some embodiments, each time insert portion 210 (or attachment portion 200, more generally) is operatively engaged with locking receptacle portion 104, e-seal device 10 (e.g., via processor 410 or other component of electronics assembly 400) may: (1) generate a new random e-seal code (see E-Seal Code 530 Data, discussed below); (2) increment a usage count (see Usage Count 560 Data, discussed below), and (3) begin a timer that tracks the period that attachment portion 200 and locking receptacle portion 104 have been engaged, thereby tracking the usage time of e-seal device 10 (see Usage Time 570 Data, discussed below).

In accordance with some embodiments, insert portion 208 may include one or more spring-tab portions 212. In accordance with some embodiments, a given spring-tab portion 212 may include a protrusion 214 extending therefrom. In some embodiments, a given protrusion 214 may be at least partially sloped or tapered on one or more of its sides. The angle of sloping or tapering may be customized, as desired for a given target application or end-use, and in at least some instances may be sufficient to enable key 300 (discussed below) to contact and slide over protrusion(s) 214 in operatively engaging key 300 with openings 108 of body portion 102. The dimensions, quantity, and arrangement of spring tab-portion(s) 212 and protrusion(s) 214 may be customized, as desired for a given target application or end-use.

In accordance with some embodiments, insert portion 208 may be configured such that when it is inserted within locking receptacle portion 104, spring-tab portion(s) 212 are deflected (e.g., against a biasing force) by the internal sidewall of locking receptacle portion 104 and then permitted to spring back into position such that associated protrusion(s) 214 come into engagement with corresponding opening(s) 108 of housing 102. In this manner, insert portion 208 may be permitted to be inserted into locking receptacle portion 104 with relative ease, but prevented from being withdrawn therefrom without use of key 300 (discussed below) or forceful means. Thus, in a general sense, operative interfacing of insert portion 208 with housing 102 may serve as a physical retention mechanism of e-seal device 10, in accordance with some embodiments.

In accordance with some embodiments, a forward end 210 of insert portion 208 may have one or more grooves 216 defined therein. A given groove 216 may be configured, in accordance with some embodiments, to host a given electrically conductive trace 224 (discussed below) of attachment portion 200. The dimensions, quantity, and geometry of groove(s) 216 may be customized, as desired for a given target application or end-use. In some embodiments, insert portion 208 may include a pair of opposing grooves 216 formed in forward end 210, each of the grooves 216 being generally U-shaped.

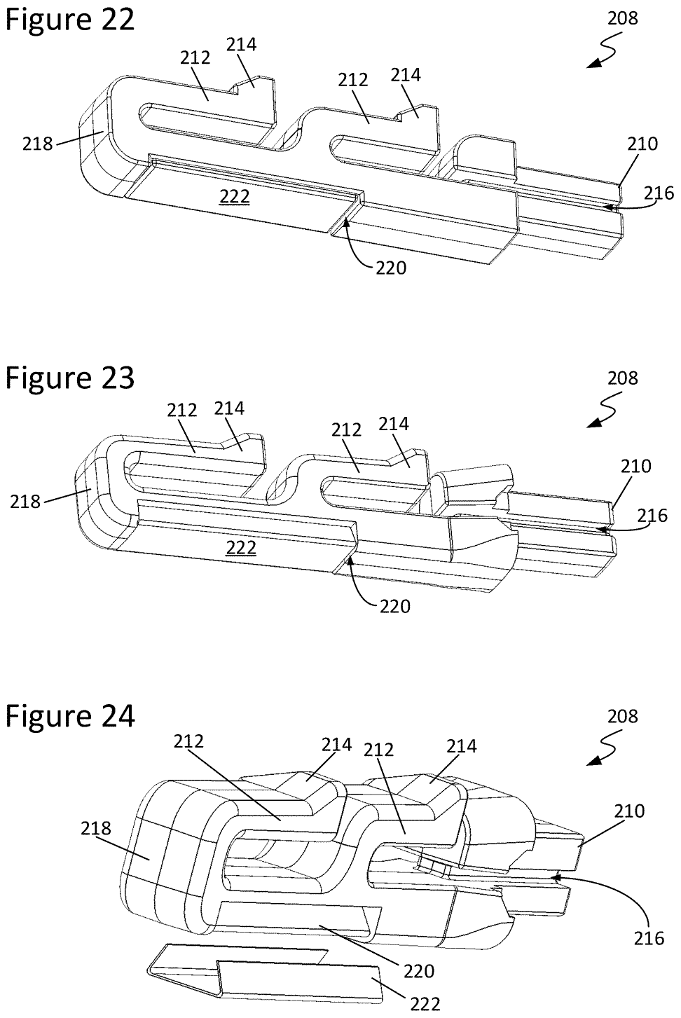

In accordance with some embodiments, a rearward end 218 of insert portion 208 may have a recess 220 defined therein. In some embodiments, recess 220 may be formed on an underside of insert portion 208. Recess 220 may be configured, in accordance with some embodiments, to host a metal body 222. FIGS. 22-24 illustrate several views of an insert portion 208 including a metal body 222 configured in accordance with an embodiment of the present disclosure. As can be seen, metal body 222 may be disposed on an underside (e.g., within a recess 220) of insert portion 208, in accordance with some embodiments. In some cases, metal body 222 may be a separate and distinct element from insert portion 208 and affixed therewith (e.g., via an adhesive, fastener, crimping, or other suitable affixing means) in a temporary or permanent manner, as desired. In some other cases, metal body 222 may be integrated with insert portion 208 (e.g., such by being molded together). The dimensions and geometry of both recess 220 and metal body 222 may be customized, as desired for a given target application or end-use. Moreover, the material composition of metal body 222 may be customized, as desired for a given target application or end-use. In an example case, metal body 222 may be formed, in part or in whole, from aluminum (Al), though other suitable metals and alloys will be apparent in light of this disclosure.

Attachment portion 200 further may include one or more electrically conductive traces 224. Electrically conductive trace(s) 224 may be embedded in body portion 202, in accordance with some embodiments. The dimensions, quantity, and material composition of electrically conductive trace(s) 224 may be customized, as desired for a given target application or end-use. In some cases, a given electrically conductive trace 224 may be any one, or combination, of electrically conductive metals or alloys, such as copper (Cu), tungsten (W), or aluminum (Al), among others. It should be noted, however, that electrically conductive trace(s) 224 are not so limited only to electrically conductive metals and alloys, as in accordance with some other embodiments, a given electrically conductive trace 224 may be a composite or polymer (e.g., ceramics, plastics, and so forth) doped with electrically conductive material(s).

In accordance with some embodiments, a single electrically conductive trace 224 may be embedded within body portion 202, running from first end 204 to second end 206 and then back to first end 204 of body portion 202. Thus, in this example configuration, electrically conductive trace 224 may make a generally U-shaped electrical connection looping through body portion 202. Furthermore, in this example configuration, the two free ends 226 of electrically conductive trace 224 may terminate at first end 204 of body portion 202, whereas the midpoint (or other intermediate point along the length of electrically conductive trace 224 between its two free ends 226) may terminate at second end 206 of body portion 202. The two free ends 226 may be electrically coupled with electronics assembly 400 (e.g., at PCB 402 thereof). In this manner, electrically conductive trace 224 and electronics assembly 400 may form a circuit. If this circuit is broken (e.g., such as by cutting or otherwise sufficiently damaging attachment portion 200 or body portion 100 of e-seal device 10), then electronics assembly 400 may register that the e-seal has been compromised.

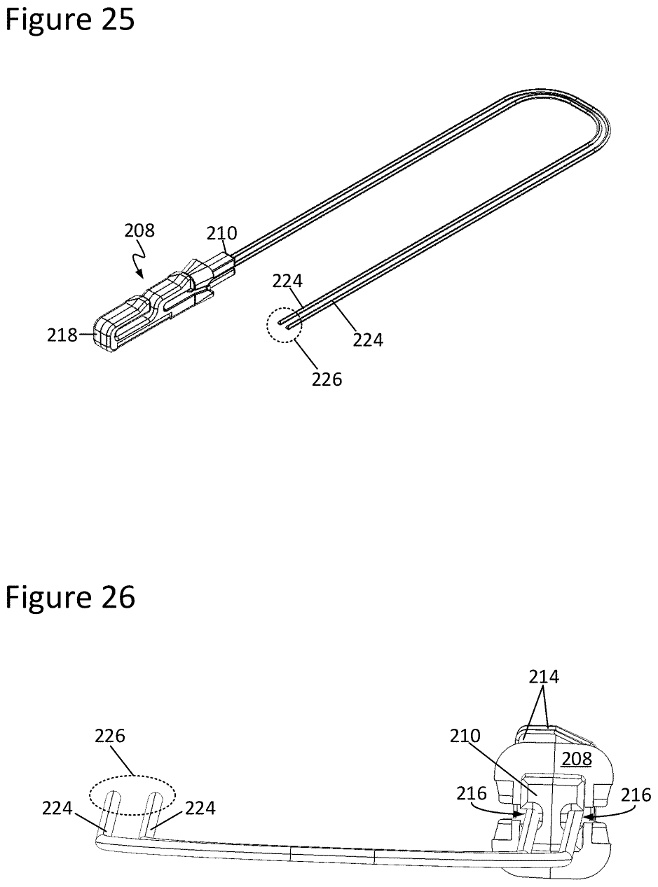

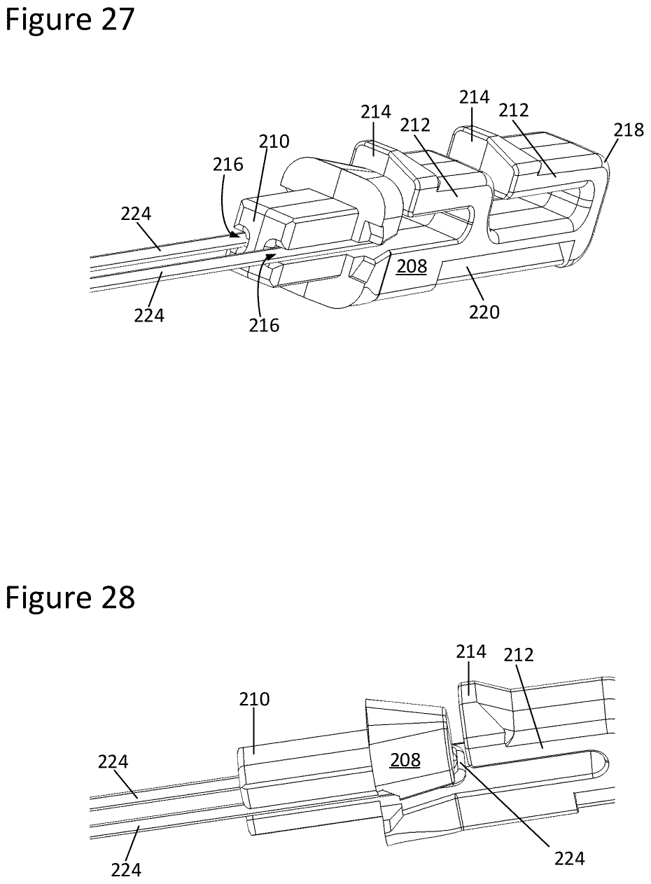

In accordance with some embodiments, electrically conductive trace(s) 224 may be configured to operatively interface with insert portion 208. FIGS. 25-28 illustrate several views of an electrically conductive trace 224 interfaced with insert portion 208 of attachment portion 200, in accordance with an embodiment of the present disclosure. As can be seen, electrically conductive trace 224 may be disposed within groove(s) 216 such that it runs along a first side of forward end 210, loops around the back of forward end 210, and runs along a second side of forward end 210. More generally, the midpoint (or other intermediate point along the length of electrically conductive trace 224 between its two free ends 226) may wrap around insert portion 208, in accordance with some embodiments.

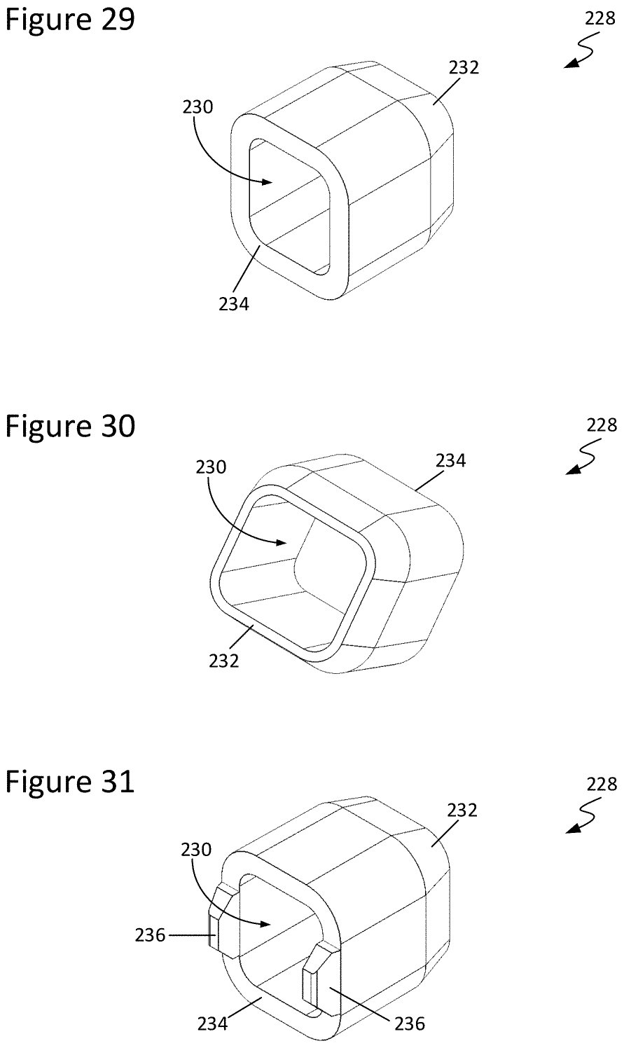

In accordance with some embodiments, e-seal device 10 may include one or more collar portions 228 configured to be operatively interfaced with body portion 100 and attachment portion 200. FIGS. 29-31 illustrate several views of a collar portion 228 configured in accordance with an embodiment of the present disclosure. As can be seen, collar portion 228 may be generally tubular in construction, having a hollow bore 230 defined therein, extending from its forward end 232 to its rearward end 234. In some embodiments, forward end 232 may be sloped or tapered inward, as generally shown. In some embodiments, rearward end 234 may include one or more protrusions 236 configured to operatively interface with housing 102 of body portion 100. The dimensions (e.g., length, width/diameter, height, sidewall thickness), geometry, and material construction of collar portion(s) 228 may be customized, as desired for a given target application or end-use.

In a general sense, a given collar portion 228 may be configured, in accordance with some embodiments, as a nut or fastener. In accordance with some embodiments, a first collar portion 228 configured to be operatively interfaced with attachment point 116 may be utilized in operatively coupling a first end 204 of attachment portion 200 with attachment point 116, thereby affixing attachment portion 200 to body portion 100 at attachment point 116. Such fixing may be provided in a permanent or temporary manner, as desired. In some instances, an adhesive material may be disposed at attachment point 116 in providing such fixing. In accordance with some embodiments, a second collar portion 228 configured to be operatively interfaced with locking receptacle portion 104 may be utilized in operatively coupling a second end 206 of attachment portion 200 with insert portion 208, thereby affixing insert portion 208 to body portion 202. Such fixing may be provided in a permanent or temporary manner, as desired.

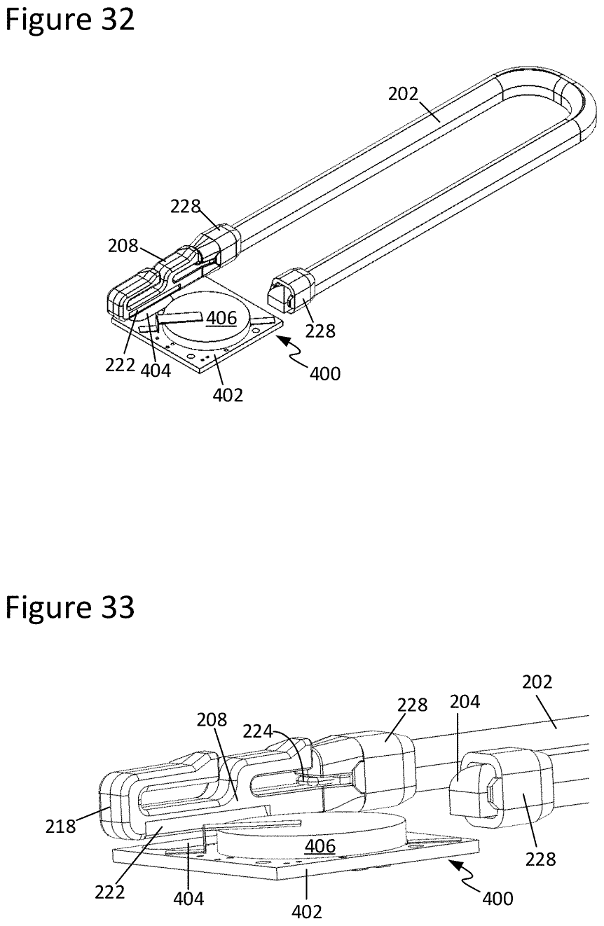

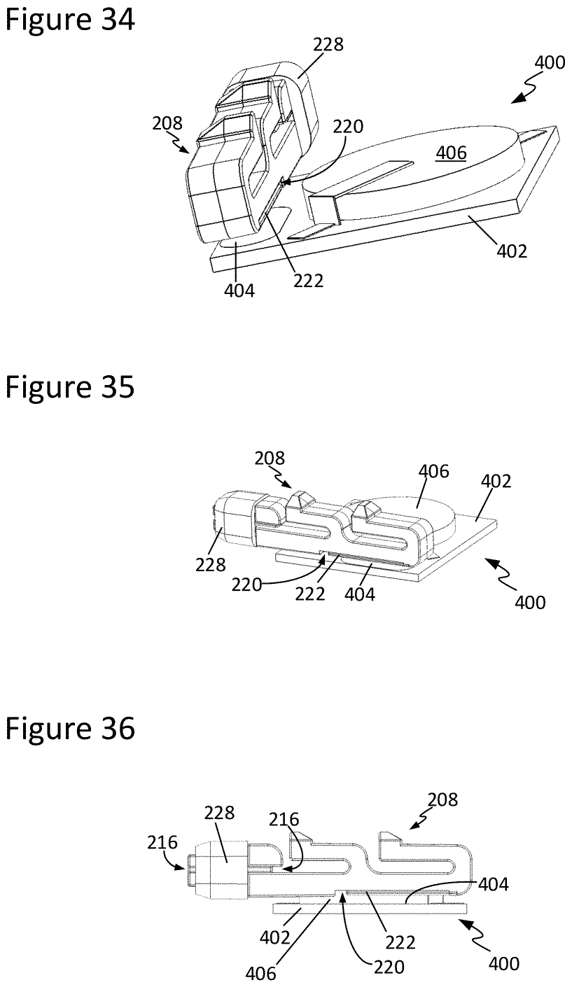

As previously noted, in operatively engaging attachment portion 200 with body portion 100, insert portion 208 may be inserted within locking receptacle portion 104, in accordance with some embodiments. FIGS. 32-36 illustrate several views of an arrangement of insert portion 208 of attachment portion 200 with respect to engagement sensor 404, in accordance with an embodiment of the present disclosure. As can be seen, by inserting insert portion 208 into locking receptacle portion 104, metal body 222 comes to reside over engagement sensor 404. Thus, in this example configuration, the presence of metal body 222 may be detected by an appropriately configured engagement sensor 404 (e.g., an inductive-type sensor). The distance between metal body 222 and engagement sensor 404 may be customized, as desired for a given target application or end-use, and in some cases may be in the range of about 20 mm or less (e.g., about 15 mm or less, about 10 mm or less, about 5 mm or less, or any other sub-range in the range of about 20 mm or less). Greater or lesser distances may be provisioned, in accordance with some other embodiments.

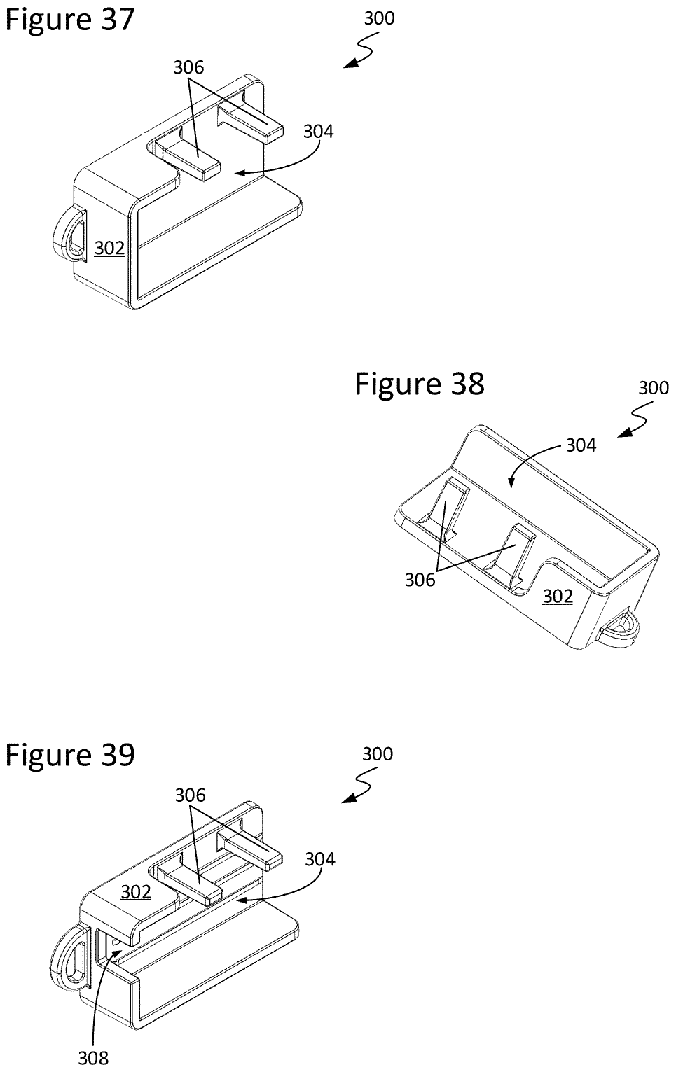

Returning to FIGS. 1-2, e-seal device 10 may include a key 300. FIGS. 37-38 illustrate several views of a key 300 configured in accordance with an embodiment of the present disclosure. FIG. 39 illustrates a key 300 configured in accordance with another embodiment of the present disclosure. Body portion 302 of key 300 may define a cavity 304 configured to receive, at least in part, housing 102 of body portion 100. Body portion 302 also may have one or more protrusions 306 (discussed below) extending therefrom. In some embodiments, body portion 302 also optionally may include a cutaway 308 configured to align with drainage hole 112 when key 300 is engaged with body portion 100. The dimensions, geometry, and material composition of key 300 may be customized, as desired for a given target application or end-use.

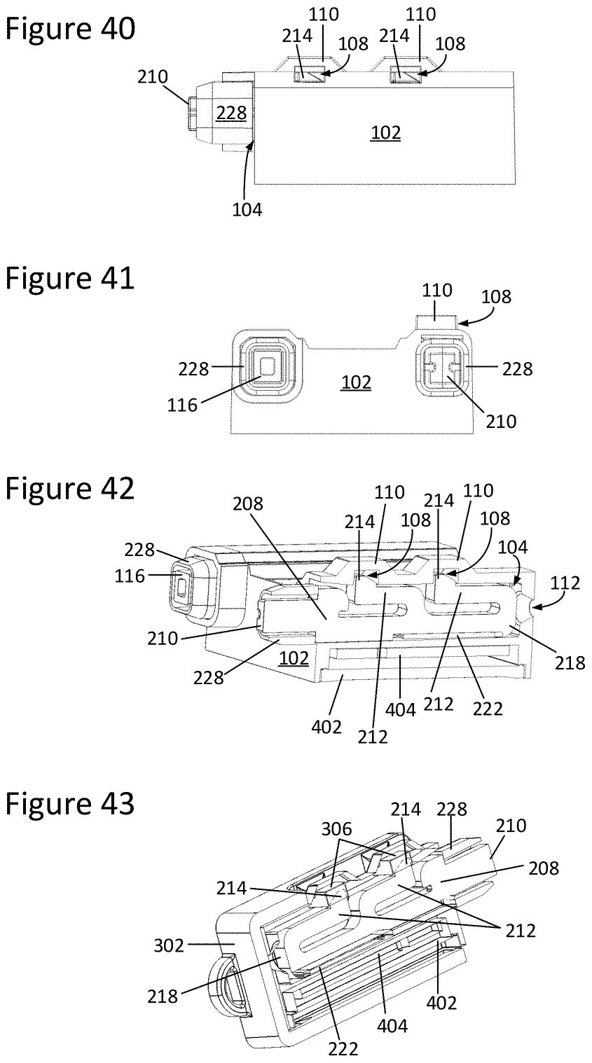

Key 300 may be configured, in accordance with some embodiments, to be operatively interfaced with body portion 100 to allow disengagement of insert portion 208 of attachment portion 200 from locking receptacle portion 104 of body portion 100 for removing e-seal device 10 from a given host platform 20. FIGS. 40-43 illustrate several views demonstrating operative engagement between key 300 and insert portion 208 of attachment portion 200 in accordance with an embodiment of the present disclosure. As can be seen, protrusion(s) 306 extending from body portion 302 may be inserted into opening(s) 108 of housing 102 and contact protrusion(s) 214 of spring-tab portion(s) 212 of insert portion 208, causing spring-tab portion(s) 212 to be depressed against their biasing force, thereby allowing insert portion 208 to be withdrawn from locking receptacle portion 104.

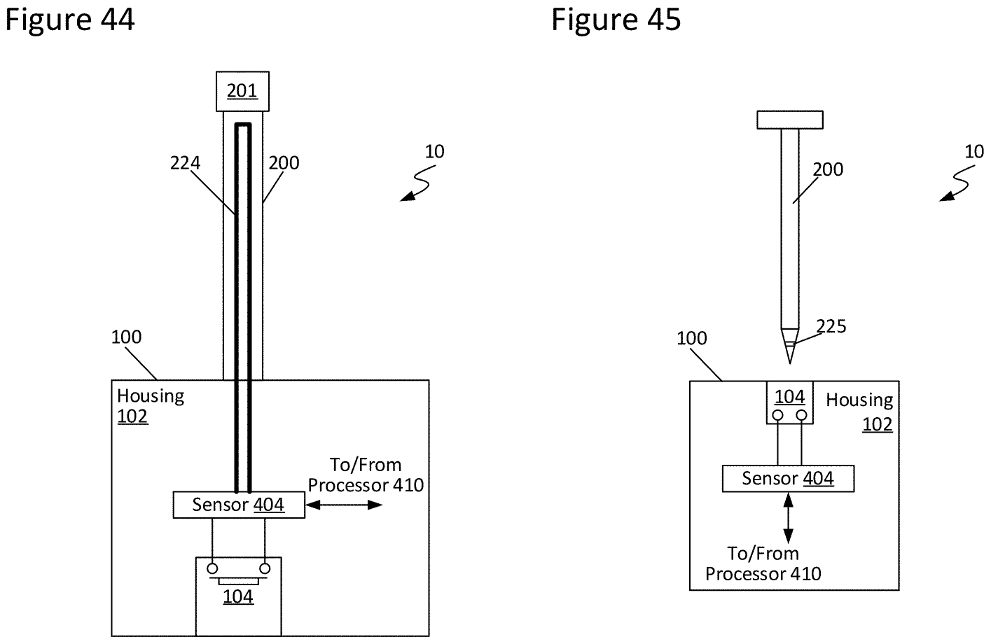

It should be noted that the present disclosure is not intended to be limited only to the example configuration(s) of e-seal device 10 discussed above, as in accordance with some other embodiments, e-seal device 10 may be of different form(s). For instance, consider FIG. 44, which illustrates an e-seal device 10 configured in accordance with another embodiment of the present disclosure. As can be seen here, attachment portion 200 may be configured as a strap. At its distal end, the strap may include a plug portion 201 configured to be received and retained by locking receptacle portion 104. The strap may include one or more electrically conductive traces 224 embedded therein. In an example case, the strap includes a single electrically conductive trace 224 that runs along the length of the strap and doubles back, forming a single loop connection extending from engagement sensor 404. Engagement sensor 404 may detect whether electrically conductive trace(s) 224 are intact and, thus, whether the strap has been broken and the e-seal compromised. To remove the strap, e-seal device 10 may include a releasing mechanism configured to provide for releasing by physically and/or magnetically activated means.

Further consider FIG. 45, which illustrates an e-seal device 10 configured in accordance with another embodiment of the present disclosure. As can be seen, attachment portion 200 may be configured as a peg. At its distal end, the peg may have one or more electrical contacts 225 configured to make electrical connection with engagement sensor 404. Engagement sensor 404 may detect whether electrical contacts 225 are in electrical connection therewith and, thus, whether the peg has been removed and the e-seal compromised. To remove the peg, e-seal device 10 may include a releasing mechanism configured to provide for releasing by physically and/or magnetically activated means. In some instances, the peg may be considered disposable.

Regardless of its particular configuration, e-seal device 10 may be constructed from any of a wide range of suitable materials. For instance, e-seal device 10 may be constructed, in part or in whole, from any one or combination of metals or alloys of metals, such as, for instance, aluminum (Al), titanium (Ti), or steel (e.g., stainless steel or other steel), among others. In some cases, e-seal device 10 may be constructed, in part or in whole, from a rubber, plastic, silicone, or other polymer or resin, a ceramic material, or a composite material. Moreover, the dimensions of e-seal device 10 may be customized, as desired for a given target application or end-use. As will be appreciated in light of this disclosure, it may be desirable to construct e-seal device 10 to be a durable and reusable apparatus. To that end, e-seal device 10 may be substantially impervious to water, dust, and other environmental hazards. Furthermore, e-seal device 10 may be configured to operate in a wide range of temperatures (e.g., ranging from −40-85° C. or broader).

Signal and Data

As previously noted, wireless transmitter 412 may be configured to output a signal 500. In accordance with some embodiments, signal 500 may be a Bluetooth signal of a frequency in an ISM band of between 2.4-2.485 GHz. In some embodiments, signal 500 may be of the Bluetooth 4.0 standard advertising beacon format, which may allow manufacturers to create custom-formatted attribute definitions and data for transmission by wireless transmitter 412. In at least some such cases, a given data packet of signal 500 may be of standard Bluetooth signal length (e.g., thirty-one bytes). In accordance with some other embodiments, signal 500 may be a cellular signal or a Wi-Fi signal of a frequency in an ISM band of between 2.4-2.485 GHz.

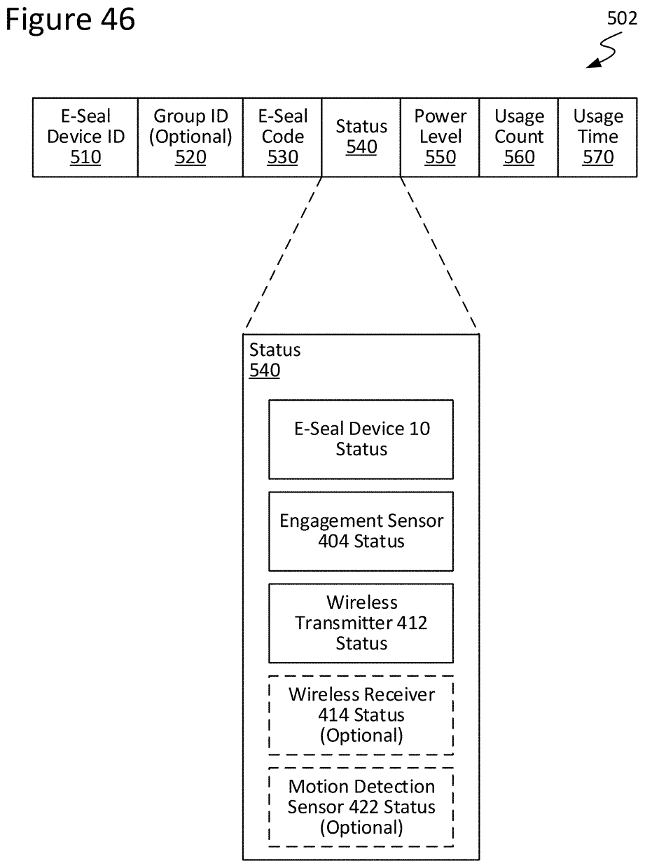

FIG. 46 represents several data fields of a data packet 502 which may be transmitted in a signal 500 by e-seal device 10, in accordance with an embodiment of the present disclosure. As can be seen, e-seal device 10 may transmit, via wireless transmitter 41, a data packet 502 including any one (or combination) of: (1) E-Seal Device ID 510 data; (2) Group ID 520 data; (3) E-Seal Code 530 data; (4) Status 540 data; (5) Power Level 550 data; (6) Usage Count 560 data; and (7) Usage Time 570 data. Each of these various data is discussed in turn below.

In accordance with some embodiments, e-Seal Device ID 510 data may be an identifier (e.g., such as an address or a manufacture code) unique to the source e-seal device 10 transmitting signal 500 and, as such, may be utilized as a unique identifier for each host platform 20 hosting an e-seal device 10. In an example case, E-Seal Device ID 510 data may be 6 bytes in size, though in other cases, lesser or greater byte sizes may be provided, as desired for a given target application or end-use.

In accordance with some embodiments, Group ID 520 data may be a group identifier assigned to different e-seal devices 10 and their attendant host platforms 20. Thus, in accordance with some embodiments, a plurality of e-seal devices 10 may be filtered, for example, to identify only those host platform(s) 20 associated with the group identifier(s) searched. In this manner, targeted host platform(s) 20 may be discerned readily among a larger grouping of host platform(s) 20.

In accordance with some embodiments, E-Seal Code 530 data may be an encrypted authentication code generated from a unique key stored by either (or both) e-seal device 10 and server database 1006 (discussed below). E-seal device 10 may be configured, in accordance with some embodiments, to generate a new e-seal code each time attachment portion 200 is engaged with locking receptacle portion 104 (e.g., when attaching e-seal device 10 to a host platform 20).

In accordance with some embodiments, Status 540 data may cover any of a wide range of conditions and communications pertaining to e-seal device 10. In some cases, Status 540 data may include data pertaining to the current or most recent status of e-seal device 10 generally. In some cases, Status 540 data may include data pertaining to the current or most recent status of the e-seal provided by e-seal device 10. For instance, Status 540 data may include data obtained via engagement sensor 404 which is indicative of the engagement/disengagement of attachment portion 200 and locking receptacle portion 104. In some cases, Status 540 data may include data pertaining to the current or most recent status of wireless transmitter 412 (e.g., transmitting or in a low-power state) and/or wireless receiver 414 (e.g., receiving or in a low-power state). In some cases, Status 540 data may include data pertaining to the current or most recent status of motion detection sensor 422 (e.g., in a state of motion or having received a detectable impact). As previously noted, in some embodiments, signal 500 may be of the Bluetooth 4.0 standard advertising beacon format. In some such cases, the data field in the advertising packet may be employed by e-seal device 10 to send Status 540 data. Numerous options for data which may be encoded in the Status 540 data of a given data packet 502 of signal 500 will be apparent in light of this disclosure.

In accordance with some embodiments, Power Level 550 data may be indicative of the remaining power level of power supply 550. Inclusion of Power Level 550 data in signal 500 may help to provide an early warning if a given e-seal device 10 is running low on power provided by its power supply 406. This can be used to guard against a power failure of e-seal device 10.

In accordance with some embodiments, Usage Count 560 data may be indicative of how many times e-seal device 10 has been utilized (e.g., how many e-seals it has generated). In accordance with some embodiments, a usage count may be incremented whenever insert portion 208 is operatively engaged with locking receptacle portion 104. In some cases, the total usage count may not be resettable, though in other cases, resetting to zero may be possible.

In accordance with some embodiments, Usage Time 570 data may be indicative of the total time elapsed since a given e-seal has been generated. Thus, the total usage time may be representative of exactly when (if at all) a given e-seal has been terminated, whether compromised or not. In accordance with some embodiments, the usage time calculation may begin whenever insert portion 208 is operatively engaged with locking receptacle portion 104 and may terminate either when: (1) insert portion 208 is withdrawn from locking receptacle portion 104; (2) attachment portion 200 is damaged such that a circuit formed by electrically conductive trace(s) 224 is broken; or (3) when e-seal device 10 is sufficiently damaged.

System Architecture and Operation

FIG. 47 illustrates a wireless electronic seal (e-seal) monitoring system 1000 configured in accordance with an embodiment of the present disclosure. As can be seen, system 1000 may include: (1) one or more e-seal devices 10 hosted by one or more host platforms 20; (2) a gateway 1002; and (3) a server database 1006. Moreover, in accordance with some embodiments, system 1000 may involve in its operation one or more reader devices 1010, the internet 1004, and one or more computing devices 1008. In accordance with some embodiments, system 1000 may involve in its operation one or more cellular data elements, such as a cellular base station 1012 and a cellular provider network 1014. Each of these various elements is discussed in turn below. More generally, FIG. 47 illustrates communicative coupling of the various constituent elements of system 1000 and the overall flow of data within system 1000, in accordance with some embodiments.

Signal 500 may be received by any one (or combination) of a reader device 1010, gateway 1002, cellular base station 1012, and cellular provider network 1014 within range, and information therefrom may be delivered through the internet 1004 to a server database 1006. The information stored at server database 1006 may be accessed to monitor and track a given e-sealed platform 20 and control overall system 1000 operation. Data may be viewed, for instance, by a computing device 1008 via a web browser or other suitable means and/or by a reader device 1010 having access to server database 1006. In accordance with some embodiments, enabling/disabling of e-seal tamper alerting for e-seal device 10 may be performed by an authorized user, for example, via an application on reader device 1010 or on computing device 1008 having an interface with server database 1006. In accordance with some embodiments, disengagement of e-seal device 10 from its host platform 20, even using key 300, without first disabling the e-seal alarm on server database 1006 may signal to server database 1006 that the e-seal has been tampered with, and an alert may be generated. In accordance with some embodiments, e-seal device 10 itself may have no knowledge of when an alert condition is generated or not.

Gateway 1002 may be configured, in accordance with some embodiments, to receive data gathered from e-seal device(s) 10 and transmit that data to a server database 1006 via internet 1004. To such ends, gateway 1002 may be configured to utilize any one or combination of suitable communication protocols, wired or wireless, such as, for example, Ethernet, Bluetooth, Wi-Fi, and cellular, among others. In accordance with some embodiments, gateway 1002 may be any one, or combination, of fixed Bluetooth-to-Wi-Fi, cellular-to-Wi-Fi, or cellular-to-Bluetooth bridge/hub devices. Gateway 1002 may be used to read all signal(s) 500 from e-seal device(s) 10 within range and to forward the information over a network interface to internet 1004 and server database 1006. In accordance with some embodiments, gateway 1002 may be configured to receive such a signal 500 and relay information obtained therefrom to server database 1006, providing for a mechanism by which the e-seal integrity status of e-seal device(s) 10 of system 1000, in part or in whole, may be determined.

System 1000 further may involve use of one or more reader devices 1010, mobile or otherwise. A given reader device 1010 may be any one, or combination, of a laptop/notebook computer, a sub-notebook computer, a tablet computer, a desktop computer, a mobile phone, a smartphone, a personal digital assistant (PDA), and a cellular handset. In accordance with some embodiments, reader device 1010 may be configured for monitoring and controlling operation of any part or the totality of system 1000 and its various constituent elements. In some cases, reader device 1010 may be a dedicated reader device configured specifically to such ends, whereas in some other cases, reader device 1010 may be a general computing device configured for use to such ends, optionally hosting one or more applications to facilitate its use in monitoring and controlling operation of system 1000. In accordance with some embodiments, reader device 1010 may be utilized in assigning/pairing a given e-seal device 10 with a given host platform 20 and in searching for and filtering through e-seal devices 10. In accordance with some embodiments, reader device 1010 may pull from server database 1006 any user-designated names of e-seal devices 10 and display them for user review, thereby facilitating the user's understanding of which specific e-sealed assets and which specific locations through which the assets have traveled are being considered. In accordance with some embodiments, reader device 1010 may be configured to send out data pertaining to only the e-seal (and, correspondingly, e-seal device 10) with which it has been paired. As will be appreciated in light of this disclosure, this may help to prevent reader device 1010 from sending data to server database 1006 for other nearby e-seal devices 10 and e-seals.

Server database 1006, which may be accessible through the internet 1004, may be cloud-based, in part or in whole. As a means of data storage, server database 1006 may be configured to store information saved thereat, for instance, by any of e-seal device(s) 10, reader device(s) 1010, and computing device(s) 1008. In an example case, server database 1006 may store information about assignment/pairing of a given e-seal device 10 with a given host platform 20, which may be retrieved by reader device 1010 or computing device 1008, for example. In another example case, server database 1006 may store information about user-designated familiar names for e-seal devices 10, which may be retrieved by reader device 1010 or computing device 1008, for example. That is, reader device 1010 may read the actual Device ID 510 (from an e-seal device 10), compare that with data on server database 1006, and pull the designated familiar name from server database 1006 for review by the user, helping to ensure that the user understands which elements of system 1000 are being considered at a time. In accordance with some embodiments, server database 1006 may be configured to verify that system 1000 is properly working and that the power supply status of all e-seal devices 10 is good. In a more general sense, server database 1006 may allow for a given desired degree of inter-networking of the components of system 1000 and other elements as part of the internet of things (TOT), in accordance with some embodiments.

Computing device 1008 may be any one, or combination, of a laptop/notebook computer, a sub-notebook computer, a tablet computer, a desktop computer, a mobile phone, a smartphone, a PDA, a cellular handset, a television set, a computer monitor, and a video conferencing system. Computing device 1008 may be configured for communication with server database 1006 utilizing wired communication via Universal Serial Bus (USB), Ethernet, FireWire, or other wired communicating interfacing, wireless communication via Wi-Fi, Bluetooth, or other wireless communication interfacing, or a combination of any thereof. In accordance with some embodiments, computing device 1008 may host a browser or other software application configured to facilitate review of information pertinent to e-seal device(s) 10 or any other part or the totality of system 1000 and its various constituent elements. In some cases, computing device 1008 and reader device 1010 may be the same device.

In accordance with some embodiments, when attachment portion 200 is disengaged from locking receptacle portion 104 (e.g., in removing e-seal device 10 from host platform 20), the status of the e-seal may be detected when e-seal device 10 is next read (e.g., by a reader device 1010, gateway 1002, etc.). In the case of a reader device 1010, an application or other software may be utilized in monitoring the e-seal. In accordance with some embodiments, the application periodically may send data pertaining to the status of the e-seal and GPS coordinates to server database 1006. The location of the e-seal device 10 and status of the e-seal may be displayed via any authorized computing device 1008 having a suitable application (e.g., web browser) or other software able to access server database 1006. In reading e-seal device 10, signal 500 may be received by either (or both) gateway 1002 and reader device 1010 (e.g., in cases of a Bluetooth signal) or either (or both) cellular base station 1012 and cellular provider network 1014 (e.g., in cases of a cellular signal). The recipient of signal 500, in turn, may output to server database 1006 a signal including the E-Seal Device ID 510, the E-Seal Code 530, and the Status 540 data obtained from signal 500. A recipient of signal 500, in turn, may relay received data to server database 1006 for storage and forwarding to a given destination computing device 1008. If the e-seal has been compromised, then signal 500 may include data indicative of (1) the e-seal status, (2) the e-seal code, and (3) the usage time. Upon delivery to the recipient device, if any of these data do not match expected values, then the e-seal may be determined to have been compromised, and the host platform 20 (or its contents) may have been accessed without authorization.

Methodologies

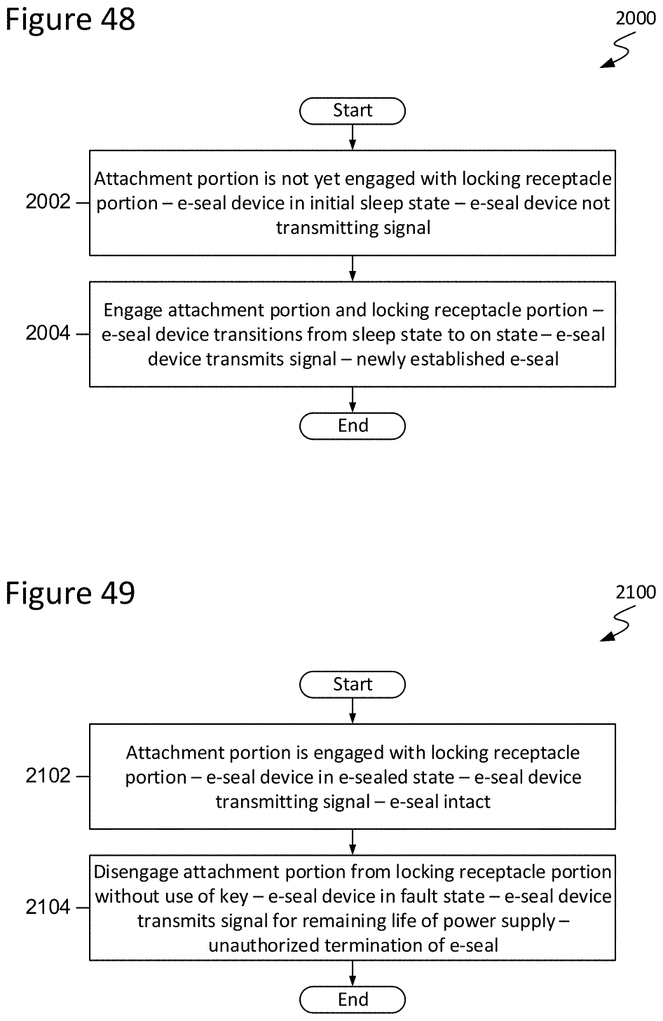

FIG. 48 is a flow diagram of a method 2000 of generating an e-seal, as provided by an e-seal device 10, in accordance with an embodiment of the present disclosure. The method 2000 may represent state machine logic for an e-seal device 10 (or system 1000, more generally), in accordance with some embodiments. The method 2000 may begin as in block 2002 with attachment portion 200 not yet being engaged with locking receptacle portion 104. In this condition, e-seal device 10 may be in an initial sleep state (or other low-power state). In this state, e-seal device 10 may not be transmitting signal 500.

The method 2000 may continue as in block 2004 with attachment portion 200 being engaged with locking receptacle portion 104. Here, e-seal device 10 may transition from a sleep state to an on state. In engaging attachment portion 200 and locking receptacle portion 104, e-seal device 10 (e.g., via processor 410 of electronics assembly 400) may: (1) generate a new random e-seal code; (2) increment a usage count; and (3) begin a timer that tracks the period that attachment portion 200 and locking receptacle portion 104 have been engaged (e.g., track the usage time of e-seal device 10). In this state, e-seal device 10 may be transmitting signal 500. Signal 500 may include data indicating, among other things, that an e-seal has been newly established.

FIG. 49 is a flow diagram of a method 2100 of terminating an e-seal, as provided by an e-seal device 10, in accordance with another embodiment of the present disclosure. The method 2100 may represent state machine logic for an e-seal device 10 (or system 1000, more generally), in accordance with some embodiments. The method 2100 may begin as in block 2102 with attachment portion 200 already being engaged with locking receptacle portion 104. Here, e-seal device 10 may be in an on state. In this state, e-seal device 10 may be transmitting signal 500. Signal 500 may include data indicating, among other things, that an e-seal has been established and is intact.

The method 2100 may continue as in block 2104 with disengaging attachment portion 200 from locking receptacle portion 104 without use of key 300. This can occur by forcefully removing insert portion 208 from locking receptacle portion 104 or breaking a circuit provided by electrically conductive trace(s) 224 of attachment portion 200. Here, e-seal device 10 may transition from its on state to a fault state. In this state, e-seal device 10 may be transmitting signal 500. Signal 500 may include data indicative of an unauthorized termination of the e-seal provided thereby. In this condition, e-seal device 10 may continue to transmit signal 500 for the remaining life of power supply 406.

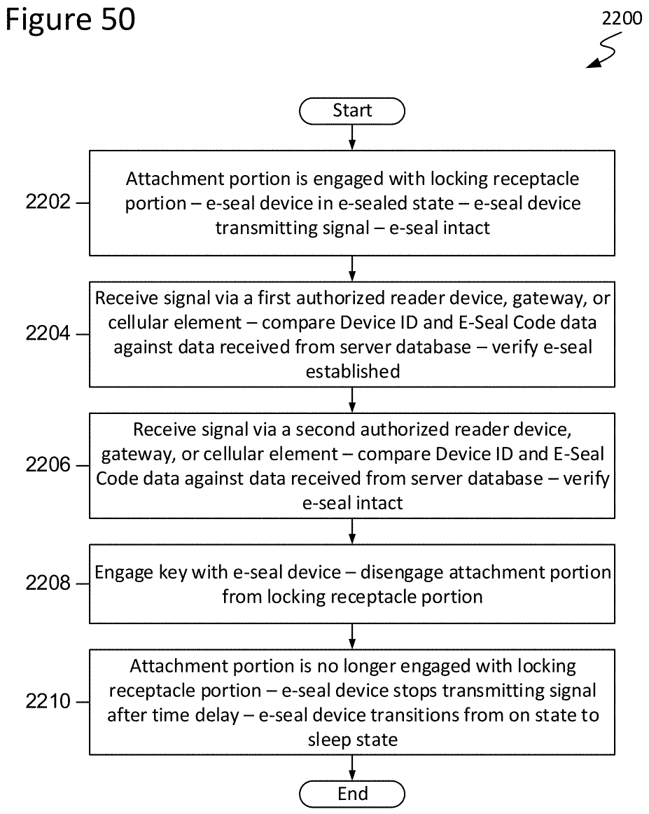

FIG. 50 is a flow diagram of a method 2200 of terminating an e-seal, as provided by an e-seal device 10, in accordance with an embodiment of the present disclosure. The method 2200 may represent state machine logic for an e-seal device 10 (or system 1000, more generally), in accordance with some embodiments. The method 2200 may begin as in block 2202 with attachment portion 200 already being engaged with locking receptacle portion 104. Here, e-seal device 10 may be in an on state. In this state, e-seal device 10 may be transmitting signal 500. Signal 500 may include data indicating, among other things, that an e-seal has been established and is intact.

The method 2200 may continue as in block 2204 with receiving signal 500 via a first authorized reader device 1010, gateway 1002, or cellular element, such as cellular base station 1012 or cellular provider network 1014. This first receiving device may be situated, for example, at a gate at the point of origin. Here, the E-Seal Device ID 510 and E-Seal Code 530 data (received via signal 500) may be compared against data received from server database 1006 to verify the e-seal and determine its status. The status of the e-seal may be set to active status on server database 1006.

The method 2200 may continue as in block 2206 with receiving signal 500 via a second authorized reader device 1010, gateway 1002, or cellular element, such as cellular base station 1012 or cellular provider network 1014. This second receiving device may be situated, for example, at a gate at the destination. Here, the E-Seal Device ID 510 and E-Seal Code 530 data (received via signal 500) may be compared against data received from server database 1006 to verify the e-seal and determine its status. If the e-seal is uncompromised, the status of the e-seal may be set to inactive status on server database 1006.

The method 2200 may continue as in block 2208 with engaging key 300 with e-seal device 10 to permit disengagement of attachment portion 200 from locking receptacle portion 104.

The method 2200 may continue as in block 2210 with attachment portion 200 no longer being engaged with locking receptacle portion 104. In this condition, e-seal device 10 may stop transmitting signal 500 after a time delay, the duration of which may be customized, as desired for a given target application or end-use. After this delay, e-seal device 10 may transition from an on state to a sleep state (or other low-power state).

### Example Applications and Contexts

As will be appreciated in light of this disclosure, e-seal device 10 may be utilized in e-sealing any of a wide range of assets and platforms 20 in any of a wide range of applications and contexts.

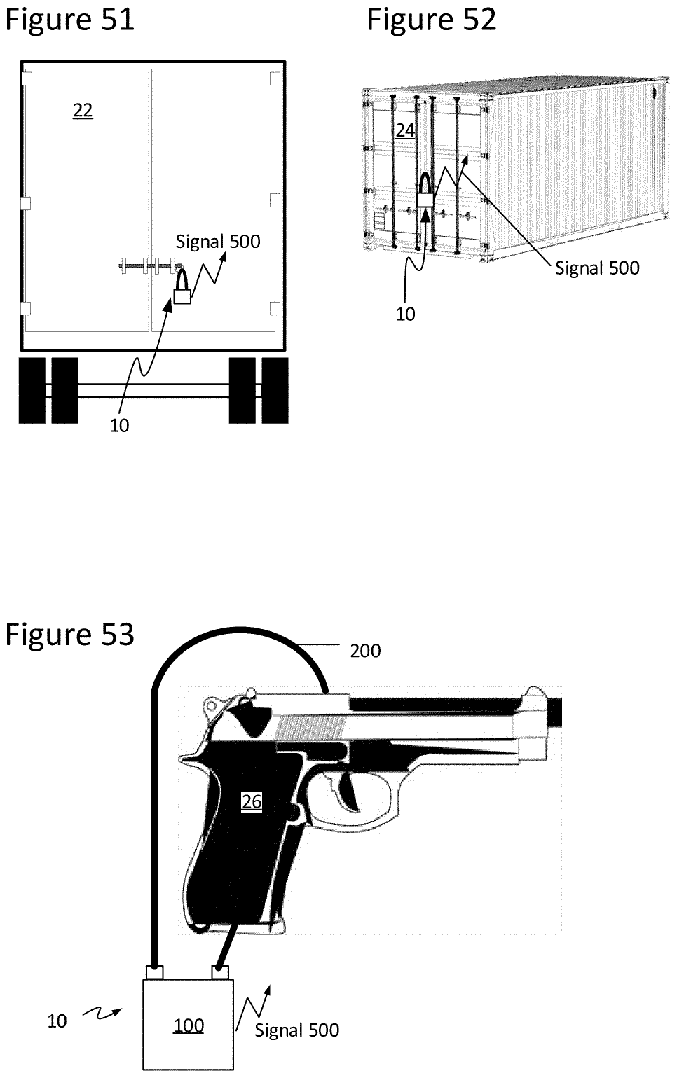

For instance, consider FIG. 51, which illustrates an example use of an e-seal device 10 with a semi-trailer 22, in accordance with an embodiment of the present disclosure. At the gate of either (or both) the originating point and a delivery location, a reader (e.g., such as a reader device 1010 or gateway 1002) may be used to read e-seal device(s) 10 passing through the gate. In accordance with some embodiments, enabling of an alert condition for e-seal device 10 may be performed automatically, such as when a semi-trailer truck transporting an e-sealed semi-trailer 22 exits a gate within range of a gateway 1002. That gateway 1002 then may signal server database 1006 of the presence of the locked e-seal, and server database 1006 automatically may set the status of the e-seal to active status. Upon arrival at the destination, another gateway 1002 at that location may read the status of the e-seal and, if the e-seal is uncompromised, then the e-seal status on server database 1006 may be changed to inactive status, at which point key 300 may be used to remove it from semi-trailer 22. Use of such reading means at the gate(s) may expedite checking semi-trailers 22 on delivery, in that trucks having semi-trailers 22 with uncompromised e-seals may be permitted to pass through the gate without further inspection or other interruption. For gate configurations where there may be multiple lanes, to determine in which lane the semi-trailer truck is situated, a micro-zone transmitter may be disposed to cover each lane, and a separate Bluetooth tag with micro-zone receiver may be mounted on the tractor unit or semi-trailer 22 itself. The fixed reader may read all signals from all semi-trailer trucks with tags and e-seal devices 10. The signals originating from the tags may include data pertaining to a micro-zone identifier, thereby identifying the lane position because the tag signals may be associated with the e-seal when the semi-trailer 22 is sealed via e-seal device 10. Also, in accordance with some embodiments, while the semi-trailer truck carrying semi-trailer 22 is in transit, the driver's reader device 1010 (e.g., smartphone) may read e-seal device 10 hosted by semi-trailer 22. In this manner, e-seal device 10 may be able to provide real-time notification of whether the e-seal is intact or has been compromised while in transit.

Also, consider FIG. 52, which illustrates an example use of an e-seal device 10 with a shipping container 24, in accordance with an embodiment of the present disclosure. It should be noted that the present disclosure is not intended to be limited only to shipping containers, as in a more general sense, and in accordance with some embodiments, e-seal device 10 may be utilized with any closeable/sealable container where unrestricted or unauthorized access to cargo/assets may be undesirable.

Further consider FIG. 53, which illustrates an example use of an e-seal device 10 with a firearm 26, in accordance with an embodiment of the present disclosure. As can be seen, e-seal device 10 may interface with any of a number of features of firearm 26 in providing an e-seal therefor. For instance, attachment portion 200 of e-seal device 10 may interface with any of a breech, a barrel, a magazine well, and/or a trigger guard of firearm 26. It should be noted that the present disclosure is not intended to be limited only to pistols, as in a more general sense, and in accordance with some embodiments, e-seal device 10 may be utilized with any firearm.

Numerous additional possible uses for e-seal device 10 will be apparent in light of this disclosure, including, but not limited to, e-sealing of sterilized medical equipment containers, hazardous materials containers, medication containers, and food/drink containers, among others.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description. Future-filed applications claiming priority to this application may claim the disclosed subject matter in a different manner and generally may include any set of one or more limitations as variously disclosed or otherwise demonstrated herein.

What is claimed is:

1. An electronic seal (e-seal) device configured to provide an e-seal for a host platform, the e-seal device comprising:
an attachment portion configured to attach the e-seal device to the host platform;
a body portion comprising:
a locking receptacle portion configured to engage with the attachment portion; and
an electronics assembly configured to detect whether the attachment portion is engaged with the locking receptacle portion, the electronics assembly comprising:
a wireless transmitter configured to transmit a signal including data pertaining to an integrity of the e-seal and comprising a unique e-seal code associated with the e-seal; and
a processor configured to instruct the wireless transmitter to transmit the signal.

2. The e-seal device of claim 1, wherein the e-seal device is configured to transmit a new unique e-seal code in the signal each time the attachment portion is engaged with the locking receptacle portion.

3. The e-seal device of claim 1, wherein the e-seal code is an encrypted authentication code generated from a unique key stored by at least one of the e-seal device and a server database external to the e-seal device.

4. The e-seal device of claim 1, wherein the data pertaining to the integrity of the e-seal further comprises:
a unique identification associated with the e-seal device; and
a status of at least one of the e-seal and the e-seal device.

5. The e-seal device of claim 4, wherein the signal further includes data pertaining to a group identifier associated with the e-seal device.

6. The e-seal device of claim 4, wherein the signal further includes data pertaining to a power level of a power supply of the e-seal device.

7. The e-seal device of claim 4, wherein the signal further includes data pertaining to at least one of:
a usage count associated with a total quantity of e-seals provided by the e-seal device; and
a usage time that the e-seal has existed.

8. The e-seal device of claim 1, wherein the signal is either a Bluetooth or a Wi-Fi signal of a frequency in an ISM band of between 2.4-2.485 GHz.

9. The e-seal device of claim 1, wherein the wireless transmitter comprises a cellular modem configured to transmit the signal as a cellular signal.

10. The e-seal device of claim 1, wherein the processor is configured to instruct the wireless transmitter to transmit the signal in response to an unauthorized disengagement of the attachment portion from the locking receptacle portion.

11. The e-seal device of claim 1, wherein:
the electronics assembly further comprises an engagement sensor;
the attachment portion comprises an insert portion disposed on an end thereof and configured to be inserted within the locking receptacle portion; and
the engagement sensor is configured detect a presence of the insert portion within the locking receptacle portion in determining whether the attachment portion is engaged with the locking receptacle portion.

12. The e-seal device of claim 11, wherein:
the engagement sensor is an inductive sensor; and
the insert portion includes a metal body configured to be detected by the inductive sensor in detecting the presence of the insert portion within the locking receptacle portion.

13. The e-seal device of claim 11, wherein:
the engagement sensor is a magnetic sensor; and
the insert portion hosts a magnetic source configured to be detected by the magnetic sensor in detecting the presence of the insert portion within the locking receptacle portion.

14. The e-seal device of claim 11, wherein:
the engagement sensor is an electrical switch configured to toggle between open and closed positions; and
the insert portion is configured to toggle the electrical switch between the open and closed positions upon insertion and withdrawal from the locking receptacle portion in detecting the presence of the insert portion within the locking receptacle portion.

15. The e-seal device of claim 1, wherein the attachment portion includes an electrically conductive trace embedded therein and configured to be electrically coupled with the electronics assembly.

16. The e-seal device of claim 15, wherein the processor is configured to instruct the wireless transmitter to transmit the signal in response to a breakage of the electrically conductive trace.

17. The e-seal device of claim 15, wherein the attachment portion is configured as a generally U-shaped body having the electrically conductive trace embedded therein.

18. The e-seal device of claim 15, wherein the attachment portion is configured as a flexible strap having the electrically conductive trace embedded therein.

19. The e-seal device of claim 1, wherein the electronics assembly further comprises a motion detection sensor configured to detect at least one of movement of the e-seal device and an impact to the e-seal device.

20. The e-seal device of claim 1, wherein the attachment portion is configured as a peg having an electrical contact disposed at an end thereof and configured to be electrically coupled with the electronics assembly.

21. The e-seal device of claim 1, wherein the processor is configured to transition out of a sleep state upon engagement of the attachment portion with the locking receptacle portion.

22. The e-seal device of any of claims 1-21, wherein:
the host platform is a semi-trailer; and
the attachment portion is configured to interface with at least one of a door and a latching mechanism of the semi-trailer.

23. The e-seal device of any of claims 1-21, wherein:
the host platform is a shipping container; and
the attachment portion is configured to interface with an enclosure mechanism of the shipping or cargo container.

24. The e-seal device of any of claims 1-21, wherein:
the host platform is a firearm; and
the attachment portion is configured to interface with at least one of a breech, a barrel, a magazine well, and a trigger guard of the firearm.

25. A method of providing an electronic seal (e-seal) via an e-seal device, the method comprising:
generating a unique e-seal code associated with the e-seal upon engagement of an attachment portion of the e-seal device with a locking receptacle portion of the e-seal device; and
transmitting, via a wireless transmitter of the e-seal device, a signal including data pertaining to an integrity of the e-seal, the data comprising the unique e-seal code associated with the e-seal.

26. The method of claim 25, wherein the transmitting occurs each time the attachment portion is engaged with the locking receptacle portion.

27. The method of claim 25, wherein the e-seal code is an encrypted authentication code generated from a unique key stored by at least one of the e-seal device and a server database external to the e-seal device.

28. The method of claim 25, wherein the data pertaining to the integrity of the e-seal further comprises:
a unique identification associated with the e-seal device; and
a status of at least one of the e-seal and the e-seal device.

29. The method of claim 28, wherein the signal further includes data pertaining to a group identifier associated with the e-seal device.

30. The method of claim 28, wherein the signal further includes data pertaining to a power level of a power supply of the e-seal device.

31. The method of claim 28, wherein the signal further includes data pertaining to at least one of:
a usage count associated with a total quantity of e-seals provided by the e-seal device; and
a usage time that the e-seal has existed.

32. The method of claim 25, wherein the signal is either a Bluetooth or a Wi-Fi signal of a frequency in an ISM band of between 2.4-2.485 GHz.

33. The method of claim 25, wherein the wireless transmitter comprises a cellular modem configured to transmit the signal as a cellular signal.

34. The method of claim 25, further comprising:
instructing, via a processor of the e-seal device, the wireless transmitter to transmit the signal.

35. The method of claim 34, wherein the instructing via the processor occurs in response to an unauthorized disengagement of the attachment portion from the locking receptacle portion.

36. The method of claim 34, wherein the instructing via the processor occurs in response to breakage of an electrically conductive trace that is embedded in the attachment portion and electrically coupled with an electronics assembly of the e-seal device.

37. The method of claim 34, further comprising:
transitioning the processor out of a sleep state upon engagement of the attachment portion with the locking receptacle portion.
